(19) United States
(12) Patent Application Publication
(10) Pub. No.: US 2024/0389025 A1
(43) Pub. Date: Nov. 21, 2024

(54) TECHNIQUES FOR SIDELINK MODE SWITCHING

(71) Applicant: QUALCOMM Incorporated, San Diego, CA (US)

(72) Inventors: Huilin XU, Temecula, CA (US); Shuanshuan WU, San Diego, CA (US); Ahmed ELSHAFIE, San Diego, CA (US); Diana MAAMARI, San Diego, CA (US)

(21) Appl. No.: 18/319,951

(22) Filed: May 18, 2023

(51) Int. Cl. H04W 52/02; H04W 72/1263; H04W 72/25; H04W 76/27

(52) U.S. Cl. CPC H04W 52/0235; H04W 52/0216; H04W 72/1263; H04W 72/25; H04W 76/27; H04W 88/06

(57) ABSTRACT

Methods, systems, and devices for wireless communications are described. A user equipment (UE) may receive control signaling indicating a configuration identifying a pattern where a network entity cycles between a first network operation state and a second network operation state, where the second network operation state may be associated with lower power consumption than the first network operation state. Based on the control signaling, the UE may switch from a first sidelink mode of operation to a second sidelink mode of operation, where sidelink communication of the UE is scheduled by the network entity for the first sidelink mode of operation and the sidelink communication of the UE is scheduled by the UE or a second UE for the second sidelink mode of operation. In response to switching, the UE may communicate, while operating in the second sidelink mode of operation, one or more sidelink messages with the second UE.

### FIELD OF TECHNOLOGY

The following relates to wireless communications, including techniques for sidelink mode switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for sidelink mode switching. For example, the described techniques provide for a user equipment (UE) to switch from a first sidelink mode of operation (e.g., sidelink mode 1) to a second sidelink mode of operation (e.g., sidelink mode 2) in response to cell discontinuous reception (DRX) and discontinuous transmission (DTX) cycles at a network entity, which may result in improved reliability for sidelink communication at the UE.

In some examples, the UE may receive control signaling that indicates a configuration of a pattern where the network entity cycles between a first network operation state (e.g., on-duration) and a second network operation (e.g., off-duration) of the cell DRX cycle, the cell DTX cycle, or both. Based on receiving the control signaling, the UE may switch from the first sidelink mode of operation to the second sidelink mode of operation, such that the UE, or a second UE, may schedule resources for sidelink communications between the UE and the second UE. Based on switching between the sidelink mode of operations, the UE may communicate, while operating in the second sidelink mode of operation, one or more sidelink messages with the second UE. In this way, the UE, or second UE, may be able to schedule resources for the sidelink communications during cell DRX and DTX cycles of the network entity, resulting in improved communication reliability, reduced latency, and more efficient utilization of communication resources.

A method for wireless communications at a UE is described. The method may include receiving control signaling indicating a configuration that identifies a pattern where a network entity cycles over time between a first network operation state and a second network operation state, the second network operation state associated with lower power consumption than the first network operation state, switching, at the UE, from a first sidelink mode of operation to a second sidelink mode of operation based on the control signaling, where sidelink communication of the UE is scheduled by the network entity for the first sidelink mode of operation, and where the sidelink communication of the UE is scheduled by the UE or a second UE for the second sidelink mode of operation, and communicating, while operating in the second sidelink mode of operation, one or more sidelink messages with the second UE based on the switching.

An apparatus for wireless communications at a UE is described. The apparatus may include one or more processors, one or more memories coupled with the one or more processors, and instructions stored in the one or more memories. The instructions may be executable by the one or more processors to cause the apparatus to receive control signaling indicating a configuration that identifies a pattern where a network entity cycles over time between a first network operation state and a second network operation state, the second network operation state associated with lower power consumption than the first network operation state, switching, at the UE, from a first sidelink mode of operation to a second sidelink mode of operation base at least in part on the control signaling, where sidelink communication of the UE is scheduled by the network entity for the first sidelink mode of operation, and where the sidelink communication of the UE is scheduled by the UE or a second UE for the second sidelink mode of operation, and communicating, while operate in the second sidelink mode of operation, one or more sidelink messages with the second UE based on the switch.

Another apparatus for wireless communications at a UE is described. The apparatus may include means for receiving control signaling indicating a configuration that identifies a pattern where a network entity cycles over time between a first network operation state and a second network operation state, the second network operation state associated with lower power consumption than the first network operation state, means for switching, at the UE, from a first sidelink mode of operation to a second sidelink mode of operation based on the control signaling, where sidelink communication of the UE is scheduled by the network entity for the first sidelink mode of operation, and where the sidelink communication of the UE is scheduled by the UE or a second UE for the second sidelink mode of operation, and means for communicating, while operating in the second sidelink mode of operation, one or more sidelink messages with the second UE based on the switch.

A non-transitory computer-readable medium storing code for wireless communications at a UE is described. The code may include instructions executable by one or more processors to receive control signaling indicating a configuration that identifies a pattern where a network entity cycles over time between a first network operation state and a second network operation state, the second network operation state associated with lower power consumption than the first network operation state, switching, at the UE, from a first sidelink mode of operation to a second sidelink mode of operation base at least in part on the control signaling, where sidelink communication of the UE is scheduled by the network entity for the first sidelink mode of operation, and where the sidelink communication of the UE is scheduled by the UE or a second UE for the second sidelink mode of operation, and communicating, while operate in the second sidelink mode of operation, one or more sidelink messages with the second UE based on the switching.

Some examples of the method, apparatuses, and non-transitory computer-readable medium described herein may further include operations, features, means, or instructions for transmitting a request to switch from the first sidelink mode of operation to the second sidelink mode of operation based on receiving the control signaling, where the switching may be based on transmitting the request.

Some examples of the method, apparatuses, and non-transitory computer-readable medium described herein may further include operations, features, means, or instructions for receiving an indication to switch from the first sidelink mode of operation to the second sidelink mode of operation, where the switching may be based on receiving the indication.

Some examples of the method, apparatuses, and non-transitory computer-readable medium described herein may further include operations, features, means, or instructions for receiving, via the control signaling, an indication of a resource pool associated with the second sidelink mode of operation, where communicating the one or more sidelink messages to the second UE may be via resources scheduled from the resource pool.

In some examples of the method, apparatuses, and non-transitory computer-readable medium described herein, the switching from the first sidelink mode of operation to the second sidelink mode of operation may be based on receiving the indication of the resource pool via the control signaling.

Some examples of the method, apparatuses, and non-transitory computer-readable medium described herein may further include operations, features, means, or instructions for receiving an indication of a transition by the network entity between the first network operation state and the second network operation state, where the switching may be based on the indication of the transition between the first network operation state and the second network operation state.

Some examples of the method, apparatuses, and non-transitory computer-readable medium described herein may further include operations, features, means, or instructions for receiving, via the control signaling, an indication of a timer associated with a transition by the network entity between the first network operation state and the second network operation state, where the switching may be based on expiration of the timer associated with the transition between the first network operation state and the second network operation state.

Some examples of the method, apparatuses, and non-transitory computer-readable medium described herein may further include operations, features, means, or instructions for receiving signaling indicative of a transition by the network entity between the first network operation state and the second network operation state, where the switching may be based on receiving the signaling.

Some examples of the method, apparatuses, and non-transitory computer-readable medium described herein may further include operations, features, means, or instructions for switching from the first sidelink mode of operation to the second sidelink mode of operation may be based on a duration of the second network operation state satisfying a timing threshold.

Some examples of the method, apparatuses, and non-transitory computer-readable medium described herein may further include operations, features, means, or instructions for switching from the first sidelink mode of operation to the second sidelink mode of operation may be based on one of a duration of the first network operation state or a duty cycle of the first network operation state failing to satisfy a timing threshold.

In some examples of the method, apparatuses, and non-transitory computer-readable medium described herein, the switching may include operations, features, means, or instructions for switching from the first sidelink mode of operation to the second sidelink mode of operation for a subset of the one or more sidelink messages based on one of a packet delay budget of each of the subset of the one or more sidelink messages, a periodicity of each of the subset of the one or more sidelink messages, or each of the subset of the one or more sidelink messages being generated during the second network operation state.

In some examples of the method, apparatuses, and non-transitory computer-readable medium described herein, the first network operation state may be an active state of a DTX cycle of the network entity and the second network operation state may be an inactive state of the DTX cycle of the network entity.

In some examples of the method, apparatuses, and non-transitory computer-readable medium described herein, the first network operation state may be an active state of a DRX cycle of the network entity and the second network operation state may be an inactive state of the DRX cycle of the network entity.

A method for wireless communications at a network entity is described. The method may include transmitting control signaling indicating a configuration that identifies a pattern where the network entity cycles over time between a first network operation state and a second network operation state, the second network operation state associated with lower power consumption than the first network operation state and communicating, with a UE, an indication to switch from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

An apparatus for wireless communications at a network entity is described. The apparatus may include one or more processors, one or more memories coupled with the one or more processors, and instructions stored in the one or more memories. The instructions may be executable by the one or more processors to cause the apparatus to transmit control signaling indicating a configuration that identifies a pattern where the network entity cycles over time between a first network operation state and a second network operation state, the second network operation state associated with lower power consumption than the first network operation state and communicating, with a UE, an indication to switch from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

Another apparatus for wireless communications at a network entity is described. The apparatus may include means for transmitting control signaling indicating a configuration that identifies a pattern where the network entity cycles over time between a first network operation state and a second network operation state, the second network operation state associated with lower power consumption than the first network operation state and means for communicating, with a UE, an indication to switch from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

A non-transitory computer-readable medium storing code for wireless communications at a network entity is described. The code may include instructions executable by one or more processors to transmit control signaling indicating a configuration that identifies a pattern where the network entity cycles over time between a first network operation state and a second network operation state, the second network operation state associated with lower power consumption than the first network operation state and communicating, with a UE, an indication to switch from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

In some examples of the method, apparatuses, and non-transitory computer-readable medium described herein, communicating with the UE may include operations, features, means, or instructions for receiving, from the UE, a request to switch from the first sidelink mode of operation to the second sidelink mode of operation in response to the control signaling.

In some examples of the method, apparatuses, and non-transitory computer-readable medium described herein, communicating with the UE may include operations, features, means, or instructions for transmitting, to the UE, an indication to switch from the first sidelink mode of operation to the second sidelink mode of operation in response to the control signaling.

Some examples of the method, apparatuses, and non-transitory computer-readable medium described herein may further include operations, features, means, or instructions for transmitting, via the control signaling, an indication of a resource pool associated with the second sidelink mode of operation, the resource pool dedicated for sidelink communications at the UE when switching from the first sidelink mode of operation to the second sidelink mode of operation.

Some examples of the method, apparatuses, and non-transitory computer-readable medium described herein may further include operations, features, means, or instructions for transmitting an indication of a transition by the network entity between the first network operation state and the second network operation state, where communicating the indication to switch may be based on the indication of the transition between the first network operation state and the second network operation state.

Some examples of the method, apparatuses, and non-transitory computer-readable medium described herein may further include operations, features, means, or instructions for transmitting, via the control signaling, a timer associated with a transition by the network entity between the first network operation state and the second network operation state, where communicating the indication to switch may be based on expiration of the timer associated with the transition between the first network operation state and the second network operation state.

Some examples of the method, apparatuses, and non-transitory computer-readable medium described herein may further include operations, features, means, or instructions for transmitting signaling indicative of a transition by the network entity between the first network operation state and the second network operation state, where communicating the indication to switch may be based on receiving the signaling.

In some examples of the method, apparatuses, and non-transitory computer-readable medium described herein, the first network operation state may be an active state of a DTX cycle of the network entity and the second network operation state may be an inactive state of the DTX cycle of the network entity.

In some examples of the method, apparatuses, and non-transitory computer-readable medium described herein, the first network operation state may be an active state of a DRX cycle of the network entity and the second network operation state may be an inactive state of the DRX cycle of the network entity.

### BRIEF DESCRIPTION OF THE DRAWINGS

FIG. 1 shows an example of a wireless communications system that supports techniques for sidelink mode switching in accordance with one or more aspects of the present disclosure.

FIG. 2 shows an example of a wireless communications system that supports techniques for sidelink mode switching in accordance with one or more aspects of the present disclosure.

FIG. 3 shows an example of a signaling diagram that supports techniques for sidelink mode switching in accordance with one or more aspects of the present disclosure.

FIG. 4 shows an example of a process flow that supports techniques for sidelink mode switching in accordance with one or more aspects of the present disclosure.

FIGS. 5 and 6 show block diagrams of devices that support techniques for sidelink mode switching in accordance with one or more aspects of the present disclosure.

FIG. 7 shows a block diagram of a communications manager that supports techniques for sidelink mode switching in accordance with one or more aspects of the present disclosure.

FIG. 8 shows a diagram of a system including a device that supports techniques for sidelink mode switching in accordance with one or more aspects of the present disclosure.

FIGS. 9 and 10 show block diagrams of devices that support techniques for sidelink mode switching in accordance with one or more aspects of the present disclosure.

FIG. 11 shows a block diagram of a communications manager that supports techniques for sidelink mode switching in accordance with one or more aspects of the present disclosure.

FIG. 12 shows a diagram of a system including a device that supports techniques for sidelink mode switching in accordance with one or more aspects of the present disclosure.

FIGS. 13 through 16 show flowcharts illustrating methods that support techniques for sidelink mode switching in accordance with one or more aspects of the present disclosure.

### DETAILED DESCRIPTION

In some wireless communications systems, a network entity may implement a cell discontinuous reception (DRX) cycle and a cell discontinuous transmission (DTX) cycle as part of network energy savings (NES). For example, the cell DRX cycle and the cell DTX cycle may include inactive periods (e.g., off-durations), such that the network entity may not transmit, nor receive, messages during such inactive periods, resulting in power savings for the network entity. Additionally, the cell DRX cycle and the cell DTX cycle may include active periods (e.g., on-durations), such that the network entity may transmit, or receive, messages during such active periods. In this way, the network entity may cycle between inactive and active periods as part of the cell DRX and cell DTX cycles in order to reduce power consumption at the network entity.

In such cases, however, if the network entity begins to operate in the cell DRX cycle, the cell DTX cycle, or both, then one or more user equipments (UEs) operating within the coverage area of the network entity may not be able to receive grants for sidelink resources in an efficient manner. For example, while operating in a first sidelink mode (e.g., sidelink mode 1), a first UE may receive, from the network entity, control signaling that schedules resources for sidelink communications between the UE and a second UE. However, during the cell DRX cycle, the cell DTX cycle, or both, the first UE may not be able to promptly receive resources for use in the sidelink communications due to the network entity periodically entering the inactive states of the cell DRX and cell DTX cycles. As such, the UE may experience increased latency for scheduling sidelink resources.

The techniques, methods, and devices described herein may enable the UE to switch from operating in the first sidelink mode to operating in a second sidelink mode (e.g., sidelink mode 2, or autonomous resource selection) based on the cell DRX cycle, the cell DTX cycle, or both of the network entity. For example, the UE may receive control signaling indicating a configuration that identifies a pattern where the network entity cycles over time between a first network operation (e.g., active period or on-duration) and a second network operation (e.g., inactive period or off-duration) of the cell DTX cycle, the cell DRX cycle, or both. Based on receiving the configuration in the control signaling, the UE may switch between the first sidelink mode to the second sidelink mode, thereby enabling the UE to autonomously schedule sidelink resources.

In this way, the UE may communicate with a second UE while operating in the second sidelink mode, thereby reducing, or otherwise eliminating, the latency associated with sidelink resource allocation during the cell DRX cycle, the cell DTX cycle, or both of the network entity. For example, by enabling the UE to switch between operating in the first sidelink mode to operating in a second sidelink mode during the cell DRX cycle, the cell DTX cycle, or both of the network entity, the UE may be able to autonomously schedule resources for sidelink communications instead of relying on (e.g., using) scheduled resources from the network entity. As such, the UE may experience reduced latency associated with scheduling resources during the cell DRX cycle, the cell DTX cycle, or both of the network entity.

Aspects of the disclosure are initially described in the context of wireless communications systems. Aspects of the disclosure are further described in the context of a signaling diagram and a process flow. Aspects of the disclosure are further illustrated by and described with reference to apparatus diagrams, system diagrams, and flowcharts that relate to techniques for sidelink mode switching.

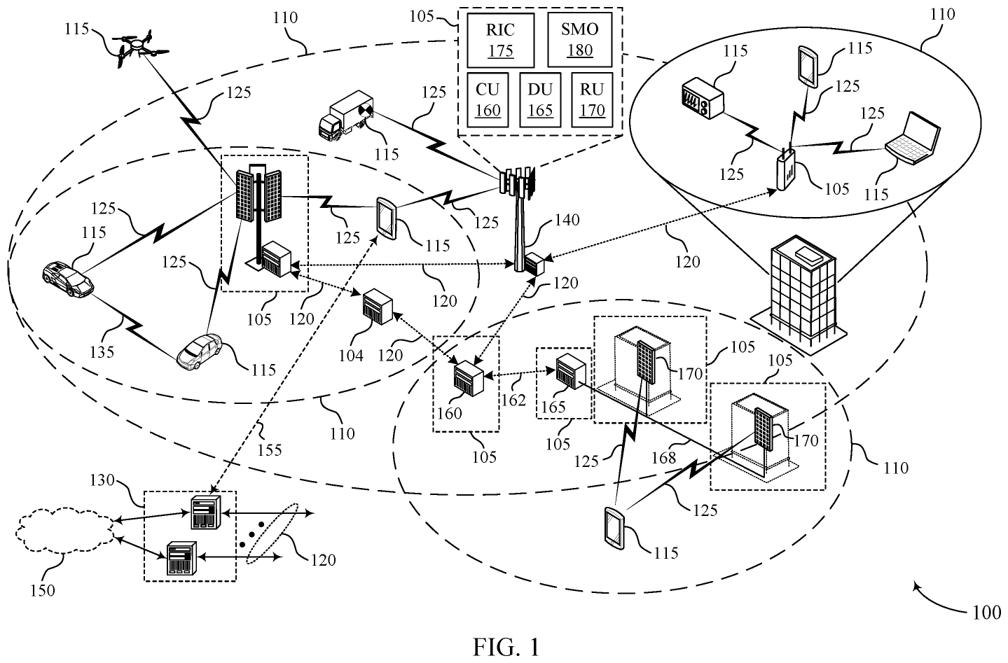

FIG. 1 shows an example of a wireless communications system 100 that supports techniques for sidelink mode switching in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for sidelink mode switching as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the network entity 105 may implement a cell DRX cycle and a cell DTX cycle as part of NESs. For example, the cell DRX cycle and the cell DTX cycle may include inactive periods (e.g., off-durations), such that the network entity 105 may not transmit, nor receive, messages during such inactive periods, resulting in power savings for the network entity 105. Additionally, the cell DRX cycle and the cell DTX cycle may include active periods (e.g., on-durations), such that the network entity 105 may transmit, or receive, messages during such active periods. In this way, the network entity 105 may cycle between inactive and active periods as part of the cell DRX and cell DTX cycles in order to reduce power consumption at the network entity 105.

In such cases, however, if the network entity 105 begins to operate in the cell DRX cycle, the cell DTX cycle, or both, then one or more UEs 115 operating within the coverage area of the network entity 105 may not be able to receive grants for sidelink resources in an efficient manner. For example, while operating in a first sidelink mode (e.g., sidelink mode 1), a first UE 115 may receive, from the network entity 105, control signaling that schedules resources for sidelink communications between the UE 115 and a second UE 115. However, during the cell DRX cycle, the cell DTX cycle, or both, the first UE 115 may not be able to promptly receive resources for use in the sidelink communications due to the network entity 105 periodically entering the inactive states of the cell DRX and cell DTX cycles. As such, the UE 115 may experience increased latency for scheduling sidelink resources.

The techniques, methods, and devices described herein may enable the UE 115 to switch from operating in the first sidelink mode to operating in a second sidelink mode (e.g., sidelink mode 2, or autonomous resource selection) based on the cell DRX cycle, the cell DTX cycle, or both of the network entity 105. For example, the UE 115 may receive control signaling indicating a configuration that identifies a pattern where the network entity 105 cycles over time between a first network operation (e.g., active period or on-duration) and a second network operation (e.g., inactive period or off-duration) of the cell DTX cycle, the cell DRX cycle, or both. Based on receiving the configuration in the control signaling, the UE 115 may switch between the first sidelink mode to the second sidelink mode, thereby enabling the UE 115 to autonomously schedule sidelink resources. In this way, the UE 115 may communicate with a second UE 115 while operating in the second sidelink mode via autonomously scheduled resources.

By implementing such techniques, the UE 115 may communicate with a second UE 115 while operating in the second sidelink mode, thereby reducing, or otherwise eliminating, the latency associated with sidelink resource allocation during the cell DRX cycle, the cell DTX cycle, or both of the network entity 105. For example, by enabling the UE 115 to switch between operating in the first sidelink mode to operating in a second sidelink mode during the cell DRX cycle, the cell DTX cycle, or both of the network entity 105, the UE 115 may be able to autonomously schedule resources for sidelink communications instead of relying on (e.g., using) scheduled resources from the network entity 105. As such, the UE 115 may experience reduced latency associated with scheduling resources during the cell DRX cycle, the cell DTX cycle, or both of the network entity 105.

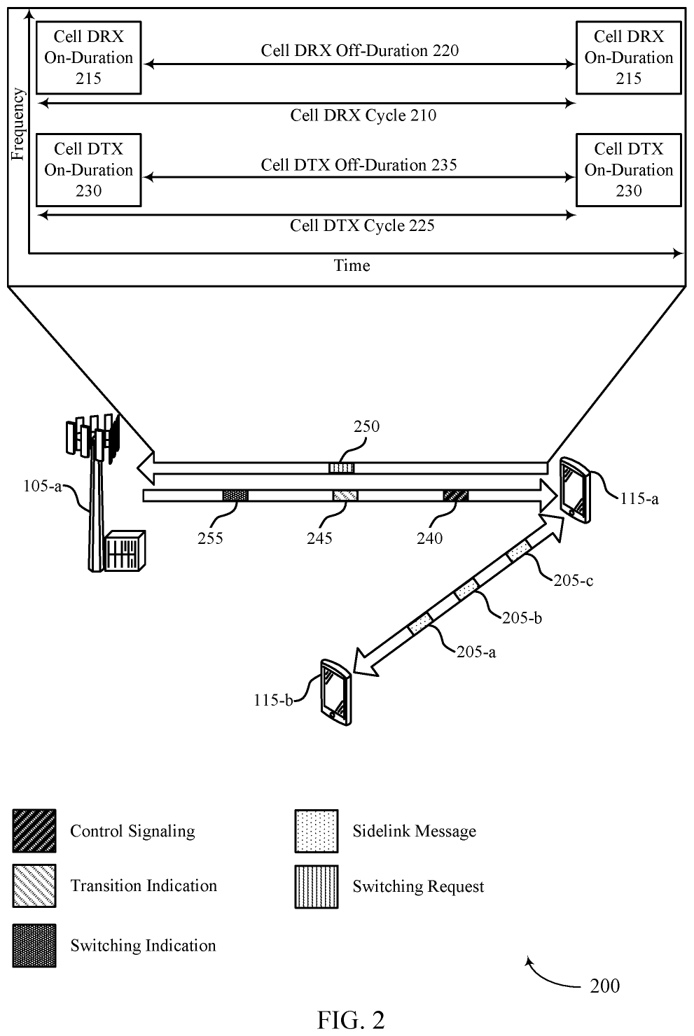

FIG. 2 shows an example of a wireless communications system 200 that supports techniques for sidelink mode switching in accordance with one or more aspects of the present disclosure. Aspects of the wireless communications system 200 may implement, or be implemented by, aspects of the wireless communications system 100 as described herein with reference to FIG. 1. For example, the wireless communications system 200 may include a UE 115-a, a UE 115-b, and a network entity 105-a, which may be examples of corresponding devices described herein. The techniques described in the context of the wireless communications system 200 may enable the UE 115-a to switch from operating in a first sidelink mode to operating in a second sidelink mode during NESs of the network entity 105-a.

For example, the UE 115-a may communicate (e.g., transmit or receive) one or more sidelink messages 205 with the UE 115-b. In order to facilitate such sidelink communications (e.g., NR sidelink communications), the UE 115-a and the UE 115-b may support two sidelink modes of operation (e.g., sidelink mode 1 and sidelink mode 2) for resource allocation. In a first sidelink mode (e.g., sidelink mode 1), the network entity 105-a may manage resource allocation for the UE 115-a and the UE 115-b. In order for the network entity 105-a to manage the resource allocation for sidelink communications, the UE 115-a and the UE 115-b may operate, or otherwise be located within, a coverage area of the network entity 105-a.

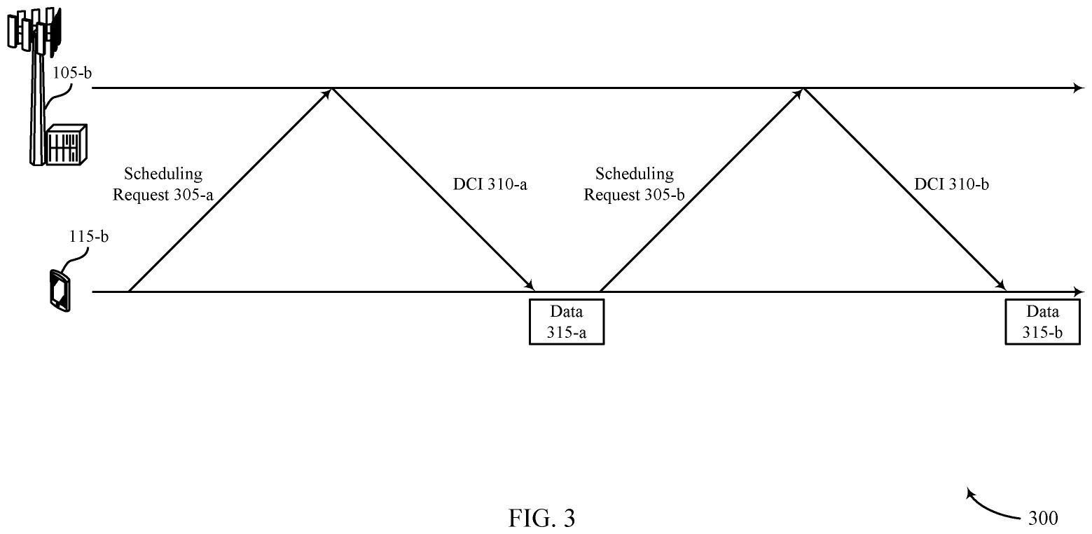

Further, in the first sidelink mode, the network entity 105-a and the UEs 115 may support both dynamic grant and configured grant based resource allocation. That is, the network entity 105-a may schedule resources for sidelink communications between the UE 115-a and the UE 115-b via a dynamic grant or configured grant. For dynamic grant resource allocation, the UE 115-a (e.g., the transmitting UE) may transmit a scheduling request to the network entity 105-a requesting resources for sidelink communications. In response, the UE 115-a may receive, from the network entity 105-a, a resource grant in downlink control information (DCI). In such examples, the UE 115-a may use one or more resources of the resource grant in order to communicate the sidelink messages 205. Such dynamic grant scheduling via the first sidelink mode may be further described herein with reference to FIG. 3.

For configured grant resource allocation, the UE 115-a (e.g., transmitting UE) may transmit a UE assistance information (UAI) to the network entity 105-a, where the network entity 105-a may determine the resources and configuration parameters for the sidelink communications between the UE 115-a and the UE 115-b. In response to receiving the UAI and determining the resources, the network entity 105-a may transmit a radio resource control (RRC) message in order to provide the configured grant resource configuration. In some examples, the network entity 105-a may additionally transmit DCI to activate the configured grant resource configuration. In this way, the UE 115-a and the UE 115-b may communicate the sidelink messages 205 via resources from a configurated grant resource configuration.

In a second sidelink mode (e.g., sidelink mode 2), the UE 115-a may determine the resource allocation for sidelink communications autonomously (e.g., on its own). For example, the UE 115-a may either use a sidelink sensing procedure (e.g., such as a listen before talk procedure) to identify available resources for data transmission or select the sidelink resources at random (e.g., perform random resource selection). While operating in the second sidelink mode, the UE 115-a may support both dynamic and semi-persistent based resource selection and reservation. That is, while operating in the second sidelink mode, the UE 115-a may dynamically or semi-persistently schedule resources for sidelink communications between the UE 115-a and the UE 115-b.

For dynamic resource selection in the second sidelink mode, the UE 115-a (e.g., the transmitting UE) may select a resource for one transport block (TB) (e.g., a sidelink message 205) and may also reserve resources (e.g., such as up to two resources) for retransmission of the TB. In this way, the UE 115-a may transmit a sidelink message 205 and retransmissions of the sidelink message 205 via resources selected according to a dynamic resource selection. Alternatively, for semi-persistent based resource selection, the UE 115-a may select and reserve resources for multiple TBs (e.g., sidelink message 205-a, sidelink message 205-b, and sidelink message 205-c) and reserve resources for retransmission of the multiple TBs. In this way, the UE 115-a may transmit multiple sidelink messages 205 via resources selected according to a semi-persistent resource selection. As described herein, the difference between the first sidelink mode and the second sidelink mode may be the involvement of the network entity 105-a for sidelink resource allocation.

Further, in some cases, the network entity 105-a may support NES in order to save network energy during both transmission and reception procedures at the network entity 105-a. For example, in order to save energy at the network entity 105-a during receptions, the network entity 105-a may implement a cell DRX cycle 210 (e.g., which may be defined from the perspective of the network entity 105-a receptions) in order to reduce the receiving operations at the network entity 105-a by limiting the transmissions from the UEs 115 to be during a cell DRX on-duration 215 (e.g., active period or first network operation state) of the cell DRX cycle 210. Unlike DRX cycles configured for the UEs 115 (e.g., which may stagger different UEs 115 in time for the case of multi-user scheduling), the cell DRX cycle 210 may be associated with a cell of the network entity 105-a (e.g., be cell specific).

That is, each UE 115 (e.g., the UE 115-a and the UE 115-b) operating within the cell, sector, or beam of the network entity 105-a may share a common cell DRX configuration, such that the network entity 105-a may enter a cell DRX off-duration 220 (e.g., inactive period, sleep mode, or second operation state) without monitoring signals from the UEs 115; otherwise, the network entity 105-a may not effectively save energy. For example, during a DRX off-duration configured for the UE 115-a, the UE 115-a may be able to transmit periodic signals via a configured grant physical uplink shared channel (PUSCH) or transmit periodic or semi-persistent sounding reference signals (SRSs), where the network entity 105-a may blindly detect such signals. However, during the cell DRX off-duration 220 of the cell DRX cycle 210, the network entity 105-a may not monitor, nor receive, such signals, thereby reducing power consumption at the network entity 105-a.

Similarly, the network entity 105-a may implement a cell DTX cycle 225 in order to reduce power consumption at the network entity 105-a. For example, the network entity 105-a may reduce power consumption by limiting transmissions from the network entity 105-a to be during a cell DTX on-duration 230 (e.g., active period or first network operation state) of the cell DTX cycle 225. In this way, the network entity 105-a may experience power reduction by not performing transmissions during a cell DTX off-duration 235 (e.g., inactive period or second network operation state) of the cell DTX cycle 225.

In some cases, the network entity 105-a may align the activity of transmission and reception of a wireless transceiver of the network entity 105-a in order to achieve additional power saving gains. That is, the network entity 105-a may assume and align the cell DTX cycle 225 with the cell DRX cycle 210 in order to further reduce power consumption and increase power (e.g., energy) saving at the network entity 105-a. For example, the network entity 105-a may be able to shut off various modules, such as a high speed clock, baseband module, or the like, when both transmissions and receptions at the network entity 105-a are inactive (e.g., off). As such, the network entity 105-a may align the cell DRX cycle 210 with the cell DTX cycle 225, such that the cell DRX on-duration 215 may be aligned with the cell DTX on-duration 230 and the cell DRX off-duration 220 may be aligned with the cell DTX off-duration 235.

Additionally, the network entity 105-a and the UEs 115 may implement various other techniques in order to improve NESs in terms of both transmission and reception at the network entity 105-a. For example, the network entity 105-a and the UEs 115 may implement more efficient operations to dynamically or semi-statically, and with a finer granularity, adapt transmissions and receptions for one or NES techniques in time domains, frequency domains, spatial domains, power domains, or a combination thereof. Further, the network entity 105-a and the UEs 115 may implement techniques, such that the network entity 105-a may support feedback from the UEs 115, such as via UAI. Further, the network entity 105-a and the UEs 115 may implement techniques for information exchange and coordination via one or more network interfaces in order to support NES. Although the above techniques may be presented as examples, it should be understood that such techniques are not all inclusive and other techniques for NES may not be precluded.

In some cases, however, if the network entity 105-a begins to operate in the cell DRX cycle 210, the cell DTX cycle 225, or both, then the UE 115-a and the UE 115-b may not be able to receive grants for sidelink resources in an efficient manner (e.g., due to the network entity 105-a not receiving or transmitting signals during such durations). For example, if the UE 115-a is operating in the first sidelink mode (e.g., sidelink mode 1), then the UE 115-a may not be able to promptly receive resources for use in the sidelink communications due to the network entity 105-a periodically entering the cell DRX off-duration 220, the cell DTX off-duration 235, or both. As such, the UE 115-a and the UE 115-b may experience an increase in latency for scheduling sidelink resources.

In accordance with the techniques described herein, the UE 115-a may switch from operating in the first sidelink mode to operating in the second sidelink mode during the cell DRX cycle 210, the cell DTX cycle 225, or both of the network entity, thereby enabling the UE 115-a to autonomously determine resources for sidelink communications. In this way, the UE 115-a may be able to reduce, or otherwise eliminate, the latency associated with scheduling sidelink resources during NES operations of the network entity 105-a.

In some examples, the UE 115-a may switch from operating in the first sidelink mode to operating in the second sidelink mode when the cell DRX cycle 210, the cell DTX cycle 225, or both are enabled at the network entity 105-a and when the network entity 105-a begins operating in (e.g., enters) the cell DRX off-duration 220, the cell DTX off-duration 235, or both. That is, the UE 115-a may switch to operating in the second sidelink mode during the cell DRX off-duration 220, the cell DTX off-duration 235, or both and switch to operating in the first sidelink mode during the cell DRX on-duration 215, the cell DTX on-duration 230, or both.

For example, the network entity 105-a may transmit control signaling 240 that includes a configuration (e.g., DRX or DTX configuration) that identifies (e.g., provides the periodic on and off durations of) the cell DRX cycle 210, the cell DTX cycle 225, or both. Further, the control signaling 240 may indicate to the UE 115-a that the cell DRX cycle 210, the cell DTX cycle 225, or both are enabled at the network entity 105-a. As such, based on the configuration included in the control signaling 240, the UE 115-a may switch from operating in the first sidelink mode to operating in the second sidelink mode based on the network entity 105-a transitioning from the cell DRX on-duration 215 to the cell DRX off-duration 220, on the network entity 105-a transitioning from the cell DTX on-duration 230 to the cell DTX off-duration 235, or both.

In such examples, the UE 115-a may switch from operating in the first sidelink mode of operation to operating in the second sidelink mode of operation based on if the cell DRX off-duration 220, the cell DTX off-duration 235, or both are insufficient (e.g., too long) for the UE 115-a to obtain resources via dynamic grant procedure (e.g., transmission of the scheduling request and reception of the DCI). That is, the UE 115-a may switch to operating in the second sidelink mode during the cell DRX off-duration 220, during the cell DTX off-duration 235, or both based on if the cell DRX off-duration 220, the cell DTX off-duration 235, or both satisfy (e.g., are greater than) an off-duration threshold; otherwise, the UE 115-a may continue to operate in the first sidelink mode. The off-duration threshold may be provided by the network entity 105-a via the control signaling or defined in a standard (e.g., such as the 3GPP standards).

Further, in such examples, the cell DRX cycle 210, the cell DTX cycle 225, or both may be periodic cycles (e.g., configured by the control signaling 240). As such, various mechanisms may be used to indicate that the network entity 105-a is transitioning to the cell DRX off-duration 220, the cell DTX off-duration 235, or both, such as dynamic signaling, timer based, outcome of other operations (e.g., such as on or off synchronization signal block (SSB) transmissions), or a combination thereof. For example, the network entity 105-a may indicate, via the control signaling 240, a timer associated with the transition to the cell DRX off-duration 220, the cell DTX off-duration 235, or both. As such, based on the expiration of the timer, the UE 115-a may switch to operating via the second sidelink operation.

Additionally, or alternatively, the network entity 105-a may transmit, to the UE 115-a, a transition indication 245 indicating that the network entity 105-a is to transition to the cell DRX off-duration 220, transition to the cell DTX off-duration 235, or both. As such, based on receiving the transition indication 245, the UE 115-a may switch from operating in first sidelink mode to operating in the second sidelink mode. The transition indication 245 may be an example of dynamic signaling, such as DCI, RRC, or medium access control (MAC) signaling. Alternatively, the transition indication 245 may be an example of various signals, such as SSB transmissions, channel state information (CSI) reference signals (CSI-RSs), or a wake-up signal (WUS).

In this way, the UE 115-a may transition from operating in the first sidelink mode to operating in the second sidelink mode during the cell DRX off-duration 220, the cell DTX off-duration 235, or both, thereby reducing latency associated with scheduling sidelink resources during such inactive periods.

In some other examples, the UE 115-a may switch from operating in the first sidelink mode to operating in the second sidelink mode when the cell DRX cycle 210, the cell DTX cycle 225, or both are enabled at the network entity 105-a. That is, in response to receiving the control signaling 240 (e.g., identifying and enabling the cell DRX cycle 210, the cell DTX cycle 225, or both), the UE 115-a may switch to operating via the second sidelink mode in order to reduce latency associated with scheduling sidelink resources.

For example, after the cell DRX cycle 210, the cell DTX cycle 225, or both are enabled, even though the cell DRX cycle 210 may include the cell DRX on-duration 215 and the cell DTX cycle 225 may include the cell DTX on-duration 230, the control message exchange (e.g., scheduling request, dynamic signaling) for the first sidelink mode between the UE 115-a and the network entity 105-a may be interrupted during such on-durations. As such, it may be desirable for the UE 115-a to switch from the first sidelink mode to the second sidelink mode in response to the cell DRX cycle 210, the cell DTX cycle 225, or both being enabled.

In such examples, the UE 115-a may switch to the second sidelink mode based on the cell DRX on-duration 215, the cell DTX on-duration 230, or both failing to satisfy (e.g., are below) an on-duration time threshold (e.g., fail to satisfy or fulfill transmission requirements). Additionally, or alternatively, in such examples, the UE 115-a may switch to the second sidelink mode based on whether the cell DRX off-duration 220, the cell DTX off-duration 235, or both satisfy (e.g., are above) the off-duration time threshold. The on-duration time threshold may correspond to a duration of time it takes for the UE 115-a and the network entity 105-a to perform the dynamic grant resource allocation as part of the first sidelink mode.

That is, if the cell DRX on-duration 215, the cell DTX on-duration 230, or both are not long enough for the UE 115-a to perform the resource request procedure within the same the cell DRX on-duration 215, the cell DTX on-duration 230, or both, then the UE 115-a may not be able to satisfy the latency requirements of the sidelink messages 205 (e.g., data transmissions). For example, the UE 115-a may not be able to receive sidelink resources and transmit sidelink messages 205 (e.g., services) with relatively tight packet delay budgets if the cell DRX on-duration 215, the cell DTX on-duration 230, or both, do not satisfy the on-duration time threshold. As an illustrative example, if the cell DRX on-duration 215, the cell DTX on-duration 230, or both are set at 5 milliseconds, then the UE 115-a may not have enough time to transmit a scheduling request and receive a dynamic resource grant within the 5 milliseconds, thereby resulting in the UE 115-a to drop, or otherwise miss, transmission of sidelink messages 205 that have packet delay budgets of 10 milliseconds due to the insufficient time to receive resources. As such, if the cell DRX on-duration 215, the cell DTX on-duration 230, or both do not satisfy the on-duration time threshold (e.g., are greater than some threshold duration of time), then the UE 115-a may switch to operating in the second sidelink mode in order to autonomously schedule resources for such sidelink messages.

Further, in such examples, the UE 115-a may switch to operating in the second sidelink mode based on respective duty cycles (e.g., respective percentages) of the cell DRX on-duration 215, the cell DTX on-duration 230, or both failing to satisfy (e.g., are below) an duty cycle duration threshold. For example, if the respective duty cycles fail to satisfy the duty cycle duration threshold, the UE 115-a and network entity 105-a may experience interruptions for the first sidelink mode resource allocation procedure. As such, the UE 115-a may switch to the second sidelink mode based on whether the respective duty cycles (e.g., respective percentages) of the cell DRX on-duration 215, the cell DTX on-duration 230, or both satisfy (e.g., are above or below) the duty cycle duration threshold.

In this way, the UE 115-a may transition from operating in the first sidelink mode to operating in the second sidelink mode based on the cell DRX cycle 210, the cell DTX cycle 225, or both being enabled at the network entity 105-a, thereby reducing latency associated with scheduling sidelink resources during such inactive periods.

In some examples, based on switching to the second sidelink mode, the UE 115-a may use resources from one of a dedicated resource pool, an exceptional resource pool, or a pre-configured resource pool in order to transmit the sidelink messages 205. That is, the UE 115-a may autonomously determine resources from one of the dedicated resource pool, the exceptional resource pool, or the pre-configured resource pool while operating in the second sidelink mode.

In one example, the network entity 105-a may configure, via the control signaling 240, the dedicated transmission resource pool for switching between the first sidelink mode to the second sidelink mode, such that UEs 115 switching from operating in the first sidelink mode to operating in the second sidelink mode may use resources of the dedicated transmission resource pool for sidelink communications while operating in the second sidelink mode of operation. That is, the UE 115-a may receive, via the control signaling 240, an indication of a resource pool that is dedicated for use by UEs 115 switching from operating via the first sidelink mode to operating via the second sidelink mode. As such, based on switching to operating via the second sidelink mode, the UE 115-a may autonomously determine one or more resources to use for transmission of the sidelink messages 205.

In another example, the UE 115-a that has switched from operating via the first sidelink mode to operating via the second sidelink mode may transmit the sidelink messages 205 using resources of the exceptional resource pool. In such examples, the network entity 105-a may configure the exceptional resource pool via the control signaling 240. For example, using current techniques, the network entity 105-a may configure the exceptional resource pool for handling exceptional cases at the UE 115-a, such as radio link failure or UE handover operations. In accordance with the techniques described herein, the UE 115-a may reuse the exceptional resource pool for sidelink communications when switching from the first sidelink mode to the second sidelink mode. As such, based on switching from the first sidelink mode to the second sidelink mode, the UE 115-a may randomly select resources from the exceptional resource pool and transmit the sidelink messages 205 via the selected resources.

In another example, the UE 115-a that has switched from operating via the first sidelink mode to operating via the second sidelink mode may transmit the sidelink messages 205 using resources of a pre-configured transmission resource pool. For example, the UE 115-a may use resources from the pre-configured transmission resource pool to transmit the sidelink messages 205 in response to switching from the first sidelink mode to the second sidelink mode, where the pre-configured transmission resource pool may be defined by a standards body for such purposes or the network entity 105-a may transmit, to the UE 115-a a control signal indicating the pre-configured transmission resource pool.

In some examples, the switch from the first sidelink mode to the second sidelink mode may be request-response based. For example, the UE 115-a may transmit, to the network entity 105-a, a switching request 250 to request to switch from operating via the first sidelink mode to operating via the second sidelink mode. In such examples, the UE 115-a may transmit the switching request 250 in response to the control signaling 240 enabling the cell DRX cycle 210, enabling the cell DTX cycle 225, or both, in response to the cell DRX on-duration 215, the cell DTX on-duration 230, or both failing to satisfy the on-duration time threshold (e.g., failing to satisfy sidelink transmission requirements), in response to the cell DRX off-duration 220, the cell DTX off-duration 235, or both satisfying the off-duration threshold, or a combination thereof. In response to receiving the switching request 250, the network entity 105-a may transmit a switching indication 255 indicating whether the UE 115-a may switch from operating via the first sidelink mode to operating via the second sidelink mode.

In some other examples, the UE 115-a may switch from operating via the first sidelink mode to operating via the second sidelink mode in accordance with an explicit indication from the network entity 105-a. For example, the network entity 105-a may transmit the switching request 250 (e.g., such as RRC signaling or a system information block (SIB) indicating for the UE 115-a to switch to operating via the second sidelink mode. In such examples, the network entity 105-a may transmit the switching information in response to, or based on, transmitting the control signaling 240 enabling the cell DRX cycle 210, the cell DTX cycle 225, or both.

In some other examples, the UE 115-a may switch from operating via the first sidelink mode to operating via the second sidelink mode based on the network entity 105-a supporting the cell DRX cycle 210, the cell DTX cycle 225, or both, on receiving the dedicated resource pool, on receiving the exceptional resource pool, on the pre-configured resource pool for the second sidelink mode being configured (e.g., activated), or a combination thereof. That is, if the network entity 105-a indicates, to the UE 115-a, support for the cell DRX cycle 210, the cell DTX cycle 225, or both, then the UE 115-a may switch to operating via the second sidelink mode. Further, if the UE 115-a receives, via the control signaling 240, the dedicated resource pool, the exceptional resource pool, or an activation indication of the pre-configured resource pool, then the UE 115-a may switch to operating via the second sidelink mode.

In some examples, the UE 115-a may switch to operating via the second sidelink mode for a subset of sidelink messages 205. For example, the UE 115-a may switch to operating via the second sidelink mode for sidelink messages 205 that have relatively tighter packet delay budgets (e.g., below a threshold packet delay budget), that have been generated during the cell DRX off-duration 220 or the cell DTX off-duration 235, that may be associated with service (e.g., application, such as extended reality (XR)) with relatively small packet periodicities, that may be associated with a service associated with a burst traffic, or the like.

As an illustrative example, the UE 115-a may have the sidelink message 205-a, the sidelink message 205-b, and the sidelink message 205-c to transmit to the UE 115-b. In such examples, the UE 115-a may switch to operating via the second sidelink mode in order to schedule resources for the sidelink message 205-b and the sidelink message 205-c based on the packet delay budget of the sidelink message 205-b being below a packet delay budget threshold and based on the sidelink message 205-c being associated with a service (e.g., such as XR) with smaller packet periodicity relative to the sidelink message 205-a. In this way, the UE 115-a may autonomously schedule resources in an efficient manner while operating via the second sidelink mode, thereby enabling the UE 115-a to transmit the sidelink message 205-b and the sidelink message 205-c according to the respective packet delay budgets or packet periodicities.

In this way, the UE 115-a may communicate with the UE 115-a while operating in the second sidelink mode, thereby reducing, or otherwise eliminating, the latency associated with sidelink resource allocation during the cell DRX cycle 210, the cell DTX cycle 225, or both of the network entity 105-a. For example, by enabling the UE 115-a to switch between operating in the first sidelink mode to operating in a second sidelink mode during the cell DRX cycle 210, the cell DTX cycle 225, or both of the network entity 105-a, the UE 115-a may be able to autonomously schedule resources for sidelink communications instead of relying on (e.g., using) scheduled resources from the network entity 105-a. As such, the UE 115-a may experience reduced latency associated with scheduling resources during the cell DRX cycle 210, the cell DTX cycle 225, or both of the network entity 105-a.

FIG. 3 shows an example of a signaling diagram 300 that supports techniques for sidelink mode switching in accordance with one or more aspects of the present disclosure. Aspects of the signaling diagram may implement, or be implemented by, aspects of the wireless communications system 100 and the wireless communications system 200 as described herein with reference to FIGS. 1 and 2 For example, the signaling diagram 300 may include a network entity 105-b and a UE 115-b, which may be examples of corresponding devices described herein.

In some cases, the UE 115-b may operate in a first sidelink mode for sidelink resource allocation. In the first sidelink mode, the network entity 105-a may manage, or otherwise provide, the resources to the UE 115-b, such that the UE 115-b may use the resources for sidelink communications with a second UE 115 (e.g., not shown). Further, in the first sidelink mode, the network entity 105-b and the UE 115-b may support dynamic grant resource allocation. For example, the UE 15-b may transmit a scheduling request 305-a in order to request resources for sidelink communications. In response, the network entity 105-a may determine the resources and transmit a resource grant via DCI 310-a. As such, the UE 115-b may use the resources of the resource grant in order to communicate (e.g., transmit or receive) sidelink data 315-a with the second UE 115.

While operating in the first sidelink mode, the UE 115-b may continue to perform such operations in order to support the sidelink communications. For example, in response to transmitting the data 315-a, the UE 115-b may transmit a scheduling request 305-b, receive a resource grant via the DCI 310-b, and communicate the sidelink data 315-b via resources of the resource grant indicated via the DCI 310-b. In this way, the network entity 105-b may manage resource allocation via dynamic grants for sidelink communications at the UE 115-b.

In some cases, the network entity 105-b may enable, or activate, a cell DTX cycle, a cell DRX cycle, or both (e.g., such as the cell DTX cycle 225 and the cell DRX cycle 210) in order to reduce power consumption at the network entity 105-b. In such cases, when the network entity 105-b begins to operate in (e.g., enters) the off durations (e.g., inactive state or second network operation state) of the cell DTX cycle, the cell DRX cycle, or both for energy saving, the network entity 105-b may stop receiving (e.g., in cell DRX off-duration) and transmitting (e.g., in cell DTX off-duration) messages for the UE 115-b (e.g., UEs 115 within the cell coverage of the network entity 105-b).

That is, the UE 115-b may not receive the scheduling DCIs 310, periodic signals (e.g., such as CSI-RS), or channels (e.g., such as semi-persistent physical downlink shared channels (PDSCHs)) during the off-durations of the cell DRX cycle, the cell DTX cycle, or both. Additionally, the UE 115-b may not transmit the scheduling requests 305, periodic signals (e.g., such as SRSs), or channels (e.g., such as configured grant PUSCHs) during the off-durations of the cell DRX cycle, the cell DTX cycle, or both.

As such, even if the UE 115-b is within the coverage area of the network entity 105-b, if the network entity 105-b enters such energy saving cycles (e.g., cell DRX cycle and cell DTX cycle), then the UE 115-b may not be able to promptly obtain resources for resource allocation while operating in the first sidelink mode, thereby resulting in increased latency in the sidelink communications. Thus, it may be desirable for the UE 115-b to switch to operating via the second sidelink mode in order to autonomously reserve resources for the transmission the sidelink data 315.

In accordance with the techniques described herein, the UE 115-b may switch from operating in the first sidelink mode to operating in a second sidelink mode (e.g., sidelink mode 2, or autonomous resource selection) based on the cell DRX cycle, the cell DTX cycle, or both of the network entity 105-b. For example, the UE 115-b may receive control signaling (e.g., such as control signaling 240) indicating a configuration that identifies a pattern where the network entity 105-b cycles over time between a first network operation (e.g., active period or on-duration) and a second network operation (e.g., inactive period or off-duration) of the cell DTX cycle, the cell DRX cycle, or both. Based on receiving the configuration in the control signaling, the UE 115-b may switch between the first sidelink mode to the second sidelink mode, thereby enabling the UE 115-b to autonomously schedule sidelink resources. The UE 115-b may communicate with a second UE 115 while operating in the second sidelink mode via the autonomously scheduled resources.

In this way, the UE 115-b may communicate with a second UE 115 while operating in the second sidelink mode, thereby reducing, or otherwise eliminating, the latency associated with sidelink resource allocation during the cell DRX cycle, the cell DTX cycle, or both of the network entity 105-b. For example, by enabling the UE 115-b to switch between operating in the first sidelink mode to operating in a second sidelink mode during the cell DRX cycle, the cell DTX cycle, or both of the network entity 105-b, the UE 115-b may be able to autonomously schedule resources for sidelink communications instead of relying on (e.g., using) scheduled resources from the network entity 105-b. As such, the UE 115-b may experience reduced latency associated with scheduling resources during the cell DRX cycle, the cell DTX cycle, or both of the network entity 105-b.

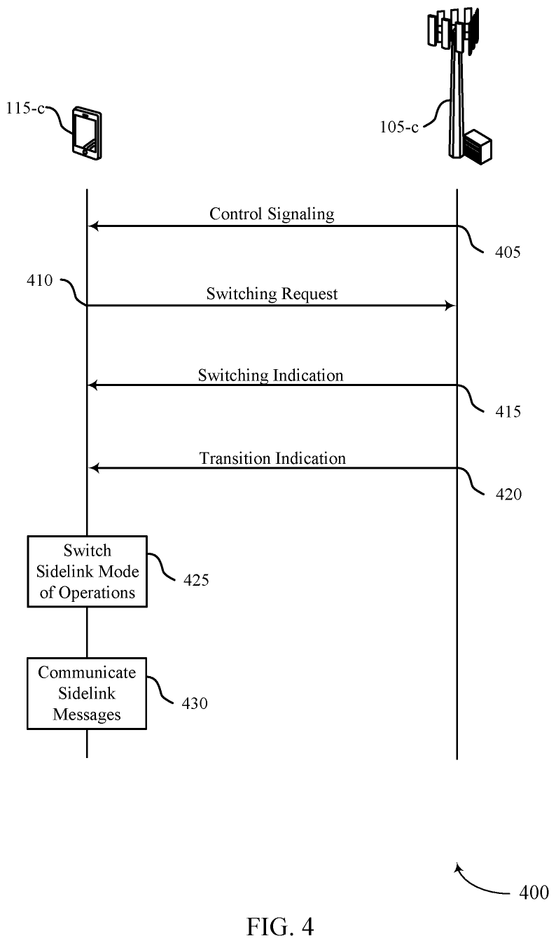

FIG. 4 shows an example of a process flow 400 that supports techniques for sidelink mode switching in accordance with one or more aspects of the present disclosure. Aspects of the process flow 400 may implement, or be implemented by, aspects of the wireless communications system 100, the wireless communications system 200, and the signaling diagram 300 as described herein with reference to FIGS. 1 through 3. For example, the process flow 400 may include a network entity 105-c and a UE 115-c, which may be examples of corresponding devices described herein. The techniques described in the context of the process flow 400 may enable the UE 115-c to switch between a first sidelink mode of operation (e.g., first sidelink mode or sidelink mode 1) and a second sidelink mode of operation (e.g., second sidelink mode or sidelink mode 2) during a cell DRX cycle, a cell DTX cycle, or both of the network entity 105-c.

At 405, the UE 115-c may receive control signaling (e.g., such as the control signaling 240) indicating a configuration that identifies a pattern (e.g., such as the cell DRX cycle 210, the cell DTX cycle 225, or both) where the network entity 105-c cycles over time between a first network operation state (e.g., such as the cell DRX on-duration 215, the cell DTX on-duration 230, or both) and a second network operation state (e.g., such as a cell DRX off-duration 220, the cell DTX off-duration 235, or both). In such examples, the second network operation state may be associated with lower power consumption at the network entity 105-b than the first network operation state.

In some examples, the network entity 105-c may transmit, via the control signaling, an indication of a resource pool (e.g., such as a dedicated resource pool or exceptional resource pool as described herein with reference to FIG. 2) associated with a second sidelink mode of operation. In some other examples, the network entity 105-c may activate, via the control signaling, a pre-configured resource pool (e.g., such as the pre-configured resource pool as described herein with reference to FIG. 2).

Further, in some examples, the network entity 105-c may receive, via the control signaling, an indication of a timer, or duration of a timer, associated with a transition by the network entity 105-b from the first network operation state to the second network operation state as described herein with reference to FIG. 2.

At 410, the UE 115-c may transmit a request (e.g., such as a switching request 250) to switch from the first sidelink mode of operation to the second sidelink mode of operation. The UE 115-c may transmit the request in accordance with the techniques described herein with reference to FIG. 2. At 415, the UE 115-c may receive an indication (e.g., such as the switching indication 255) to switch from the first sidelink mode of operation to the second sidelink mode of operation. The UE 115-c may receive the indication in accordance with the techniques described herein with reference to FIG. 2. At 420, the UE 115-c may receive signaling, an indication, or both (e.g., such as the transition indication 245) that the network entity 105-c is to transition from the first network operation state to the second network operation state.

At 425, the UE 115-c may switch from the first sidelink mode of operation to the second sidelink mode of operation. In some examples, the UE 115-c may perform the switch based on the transmitting the switching request at 410. In some other examples, the UE 115-c may perform the switch based on receiving the switching indication at 415 or based on receiving the transition indication at 420. In some examples, the UE 115-c may perform the switch based on receiving the resource pool via the control signaling at 405. In some examples, the UE 115-c may perform the switching based on expiration of the timer indicated via the control signaling at 405.

In some other examples, the UE 115-c may perform the switching based on a duration of the second network operation state satisfying a timing threshold (e.g., such as the cell DRX off-duration 220, the cell DTX off-duration 235, or both satisfying the off-duration threshold). In some other examples, the UE 115-c may perform the switch based on one of a duration of the first network operation state or a duty cycle of the first network operation state failing to satisfy a timing threshold (e.g., such as the cell DRX on-duration 215, the cell DTX on-duration 230, or both failing to satisfy the on-duration threshold or meet the transmission requirements of one or more sidelink messages).

In some examples, the UE 115-c may switch from the first sidelink mode of operation to the second sidelink mode of operation for a subset of sidelink messages based on at least one of a packet delay budget of each of the subset of the one or more sidelink messages, a periodicity of each of the subset of the one or more sidelink messages, or each of the subset of the one or more sidelink messages being generated during the second network operation state as described herein with reference to FIG. 2.

At 430, the UE 115-c may communicate, while operating in the second sidelink mode of operation, one or more sidelink messages (e.g., such as the sidelink messages 205) or a subset of the one or more sidelink messages, with a second UE 115 (not shown) based on the switching.

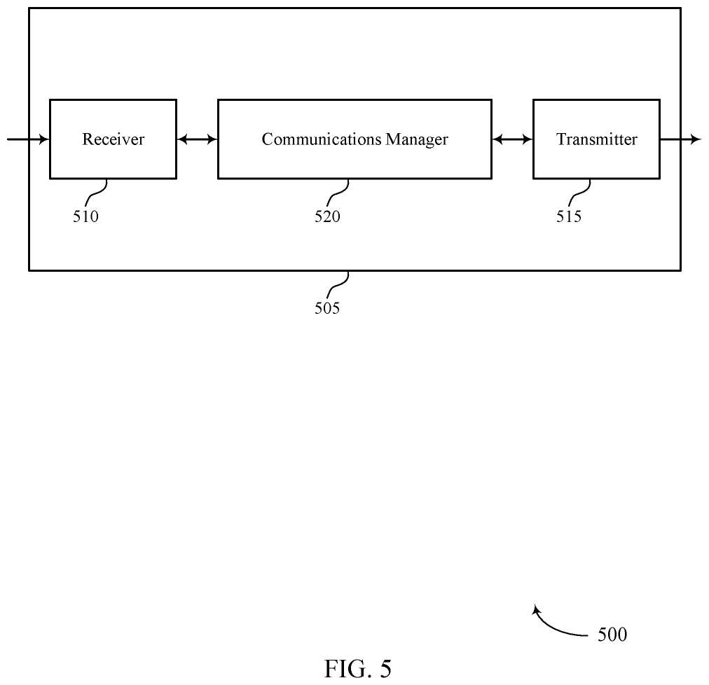

FIG. 5 shows a block diagram 500 of a device 505 that supports techniques for sidelink mode switching in accordance with one or more aspects of the present disclosure. The device 505 may be an example of aspects of a UE 115 as described herein. The device 505 may include a receiver 510, a transmitter 515, and a communications manager 520. The device 505 may also include one or more processors. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for sidelink mode switching). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for sidelink mode switching). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for sidelink mode switching as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include one or more processors, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, one or more processors and one or more memories coupled with the one or more processors may be configured to perform one or more of the functions described herein (e.g., by executing, by the one or more processors, instructions stored in the one or more memories).

Additionally, or alternatively, in some examples, the communications manager 520, the receiver 510, the transmitter 515, or various combinations or components thereof may be implemented in code (e.g., as communications management software or firmware) executed by one or more processors. If implemented in code executed by one or more processors, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for receiving control signaling indicating a configuration that identifies a pattern where a network entity cycles over time between a first network operation state and a second network operation state, the second network operation state associated with lower power consumption than the first network operation state. The communications manager 520 is capable of, configured to, or operable to support a means for switching, at the UE, from a first sidelink mode of operation to a second sidelink mode of operation based at least in part on the control signaling, where sidelink communication of the UE is scheduled by the network entity for the first sidelink mode of operation, and where the sidelink communication of the UE is scheduled by the UE or a second UE for the second sidelink mode of operation. The communications manager 520 is capable of, configured to, or operable to support a means for communicating, while operating in the second sidelink mode of operation, one or more sidelink messages with the second UE based on the switching.

By including or configuring the communications manager 520 in accordance with examples as described herein, the device 505 (e.g., one or more processors controlling or otherwise coupled with the receiver 510, the transmitter 515, the communications manager 520, or a combination thereof) may support techniques for the UE to switch from a first sidelink mode of operation to a second sidelink mode of operation in response to cell DRX or cell DTX cycles of the network entity, which may result in a more efficient utilization of communication resources.

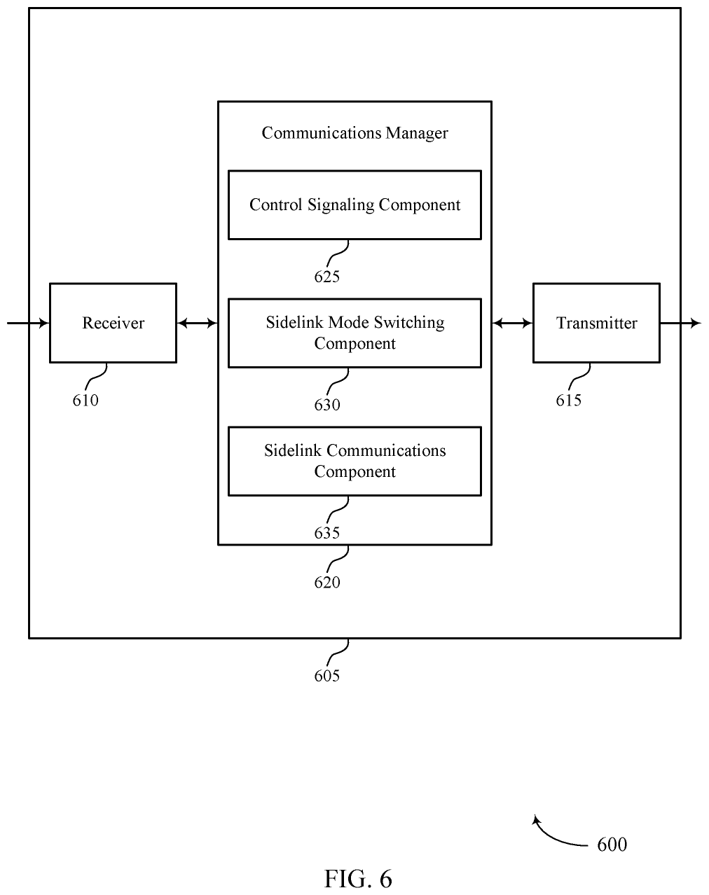

FIG. 6 shows a block diagram 600 of a device 605 that supports techniques for sidelink mode switching in accordance with one or more aspects of the present disclosure. The device 605 may be an example of aspects of a device 505 or a UE 115 as described herein. The device 605 may include a receiver 610, a transmitter 615, and a communications manager 620. The device 605 may also include one or more processors. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for sidelink mode switching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for sidelink mode switching). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for sidelink mode switching as described herein. For example, the communications manager 620 may include a control signaling component 625, a sidelink mode switching component 630, a sidelink communications component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The control signaling component 625 is capable of, configured to, or operable to support a means for receiving control signaling indicating a configuration that identifies a pattern where a network entity cycles over time between a first network operation state and a second network operation state, the second network operation state associated with lower power consumption than the first network operation state. The sidelink mode switching component 630 is capable of, configured to, or operable to support a means for switching, at the UE, from a first sidelink mode of operation to a second sidelink mode of operation based on the control signaling, where sidelink communication of the UE is scheduled by the network entity for the first sidelink mode of operation, and where the sidelink communication of the UE is scheduled by the UE or a second UE for the second sidelink mode of operation. The sidelink communications component 635 is capable of, configured to, or operable to support a means for communicating, while operating in the second sidelink mode of operation, one or more sidelink messages with the second UE based on the switching.

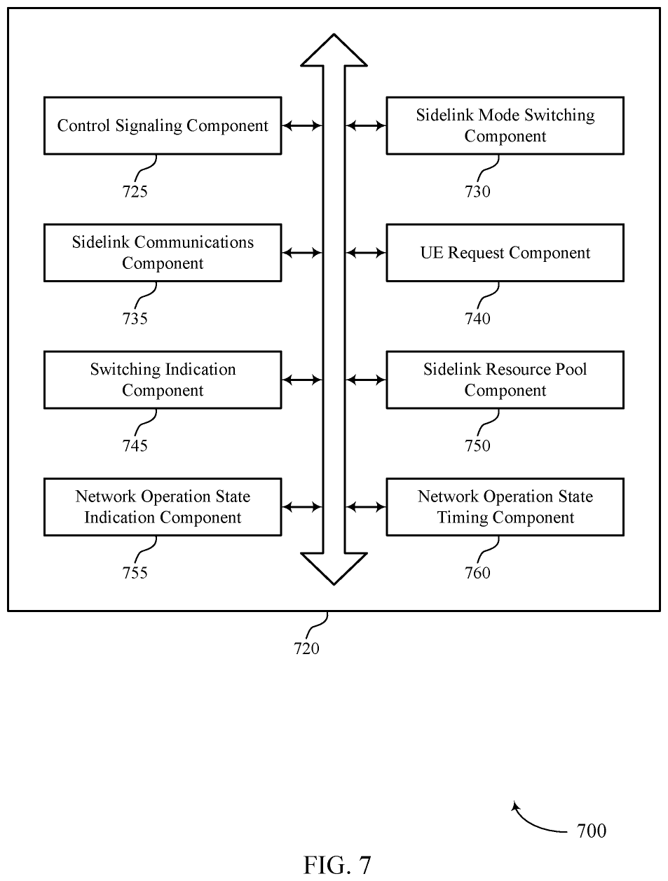

FIG. 7 shows a block diagram 700 of a communications manager 720 that supports techniques for sidelink mode switching in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for sidelink mode switching as described herein. For example, the communications manager 720 may include a control signaling component 725, a sidelink mode switching component 730, a sidelink communications component 735, a UE request component 740, a switching indication component 745, a sidelink resource pool component 750, a network operation state indication component 755, a network operation state timing component 760, or any combination thereof. Each of these components may communicate, directly or indirectly, with one another (e.g., via one or more buses).

The communications manager 720 may support wireless communications at a UE in accordance with examples as disclosed herein. The control signaling component 725 is capable of, configured to, or operable to support a means for receiving control signaling indicating a configuration that identifies a pattern where a network entity cycles over time between a first network operation state and a second network operation state, the second network operation state associated with lower power consumption than the first network operation state. The sidelink mode switching component 730 is capable of, configured to, or operable to support a means for switching, at the UE, from a first sidelink mode of operation to a second sidelink mode of operation based on the control signaling, where sidelink communication of the UE is scheduled by the network entity for the first sidelink mode of operation, and where the sidelink communication of the UE is scheduled by the UE or a second UE for the second sidelink mode of operation. The sidelink communications component 735 is capable of, configured to, or operable to support a means for communicating, while operating in the second sidelink mode of operation, one or more sidelink messages with the second UE based on the switching.

In some examples, the UE request component 740 is capable of, configured to, or operable to support a means for transmitting a request to switch from the first sidelink mode of operation to the second sidelink mode of operation based on receiving the control signaling, where the switching is based on transmitting the request.

In some examples, the switching indication component 745 is capable of, configured to, or operable to support a means for receiving an indication to switch from the first sidelink mode of operation to the second sidelink mode of operation, where the switching is based on receiving the indication.

In some examples, the sidelink resource pool component 750 is capable of, configured to, or operable to support a means for receiving, via the control signaling, an indication of a resource pool associated with the second sidelink mode of operation, where communicating the one or more sidelink messages to the second UE is via resources scheduled from the resource pool.

In some examples, the switching from the first sidelink mode of operation to the second sidelink mode of operation is based on receiving the indication of the resource pool via the control signaling.

In some examples, the network operation state indication component 755 is capable of, configured to, or operable to support a means for receiving an indication of a transition by the network entity between the first network operation state and the second network operation state, where the switching is based on the indication of the transition between the first network operation state and the second network operation state.

In some examples, the network operation state timing component 760 is capable of, configured to, or operable to support a means for receiving, via the control signaling, an indication of a timer associated with a transition by the network entity between the first network operation state and the second network operation state, where the switching is based on expiration of the timer associated with the transition between the first network operation state and the second network operation state.

In some examples, the network operation state indication component 755 is capable of, configured to, or operable to support a means for receiving signaling indicative of a transition by the network entity between the first network operation state and the second network operation state, where the switching is based on receiving the signaling.

In some examples, switching from the first sidelink mode of operation to the second sidelink mode of operation is based on a duration of the second network operation state satisfying a timing threshold.

In some examples, switching from the first sidelink mode of operation to the second sidelink mode of operation is based on one of a duration of the first network operation state or a duty cycle of the first network operation state failing to satisfy a timing threshold.

In some examples, to support switching, the sidelink mode switching component 730 is capable of, configured to, or operable to support a means for switching from the first sidelink mode of operation to the second sidelink mode of operation for a subset of the one or more sidelink messages based on one of a packet delay budget of each of the subset of the one or more sidelink messages, a periodicity of each of the subset of the one or more sidelink messages, or each of the subset of the one or more sidelink messages being generated during the second network operation state.

In some examples, the first network operation state is an active state of a DTX cycle of the network entity and the second network operation state is an inactive state of the DTX cycle of the network entity.

In some examples, the first network operation state is an active state of a DRX cycle of the network entity and the second network operation state is an inactive state of the DRX cycle of the network entity.

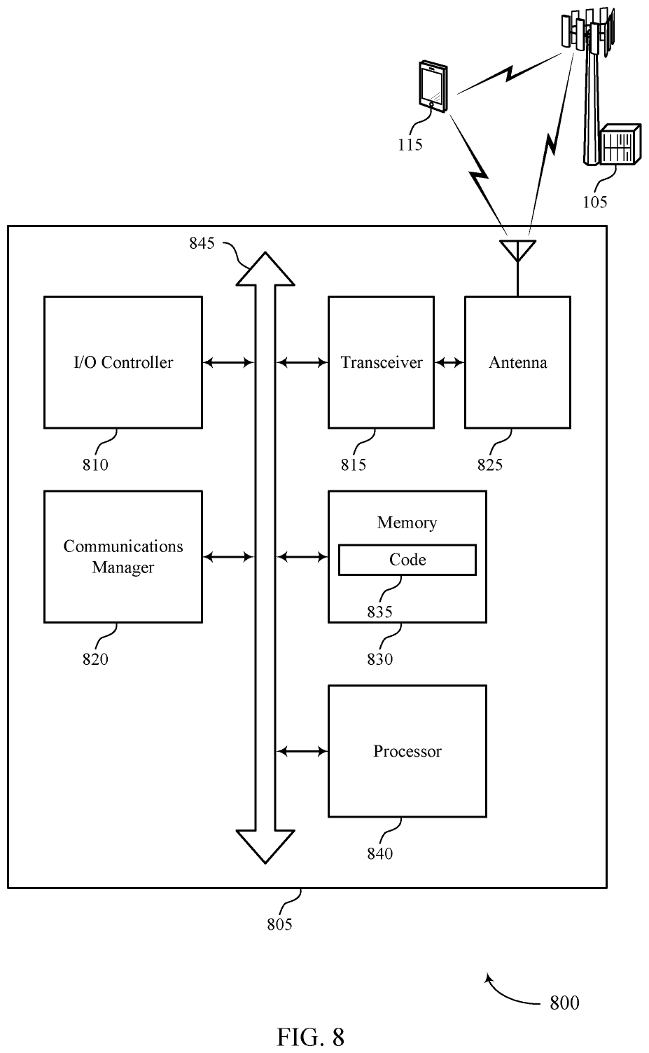

FIG. 8 shows a diagram of a system 800 including a device 805 that supports techniques for sidelink mode switching in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845). In some examples, the device 805 may include one or more processors 840 and one or more memories 830 that are configured to perform the aspects as described herein.

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for sidelink mode switching). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for receiving control signaling indicating a configuration that identifies a pattern where a network entity cycles over time between a first network operation state and a second network operation state, the second network operation state associated with lower power consumption than the first network operation state. The communications manager 820 is capable of, configured to, or operable to support a means for switching, at the UE, from a first sidelink mode of operation to a second sidelink mode of operation based at least in part on the control signaling, where sidelink communication of the UE is scheduled by the network entity for the first sidelink mode of operation, and where the sidelink communication of the UE is scheduled by the UE or a second UE for the second sidelink mode of operation. The communications manager 820 is capable of, configured to, or operable to support a means for communicating, while operating in the second sidelink mode of operation, one or more sidelink messages with the second UE based on the switching.

By including or configuring the communications manager 820 in accordance with examples as described herein, the device 805 may support techniques for the UE to switch from a first sidelink mode of operation to a second sidelink mode of operation in response to cell DRX or cell DTX cycles of the network entity, which may result in improved communication reliability, reduced latency, and more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for sidelink mode switching as described herein, or the processor 840 and the memory 830 may be otherwise configured to perform or support such operations.

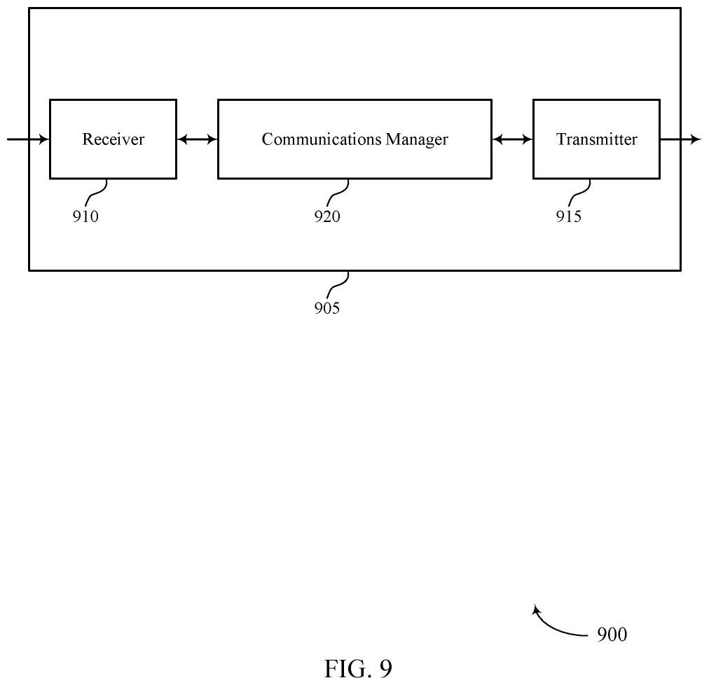

FIG. 9 shows a block diagram 900 of a device 905 that supports techniques for sidelink mode switching in accordance with one or more aspects of the present disclosure. The device 905 may be an example of aspects of a network entity 105 as described herein. The device 905 may include a receiver 910, a transmitter 915, and a communications manager 920. The device 905 may also include one or more processors. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for sidelink mode switching as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include one or more processors, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, one or more processors and one or more memories coupled with the one or more processors may be configured to perform one or more of the functions described herein (e.g., by executing, by the one or more processors, instructions stored in the one or more memories).

Additionally, or alternatively, in some examples, the communications manager 920, the receiver 910, the transmitter 915, or various combinations or components thereof may be implemented in code (e.g., as communications management software or firmware) executed by one or more processors. If implemented in code executed by one or more processors, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for transmitting control signaling indicating a configuration that identifies a pattern where the network entity cycles over time between a first network operation state and a second network operation state, the second network operation state associated with lower power consumption than the first network operation state. The communications manager 920 is capable of, configured to, or operable to support a means for communicating, with a UE, an indication to switching from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

By including or configuring the communications manager 920 in accordance with examples as described herein, the device 905 (e.g., one or more processors controlling or otherwise coupled with the receiver 910, the transmitter 915, the communications manager 920, or a combination thereof) may support techniques for the UE to switch from a first sidelink mode of operation to a second sidelink mode of operation in response to cell DRX or cell DTX cycles of the network entity, which may result in a more efficient utilization of communication resources.

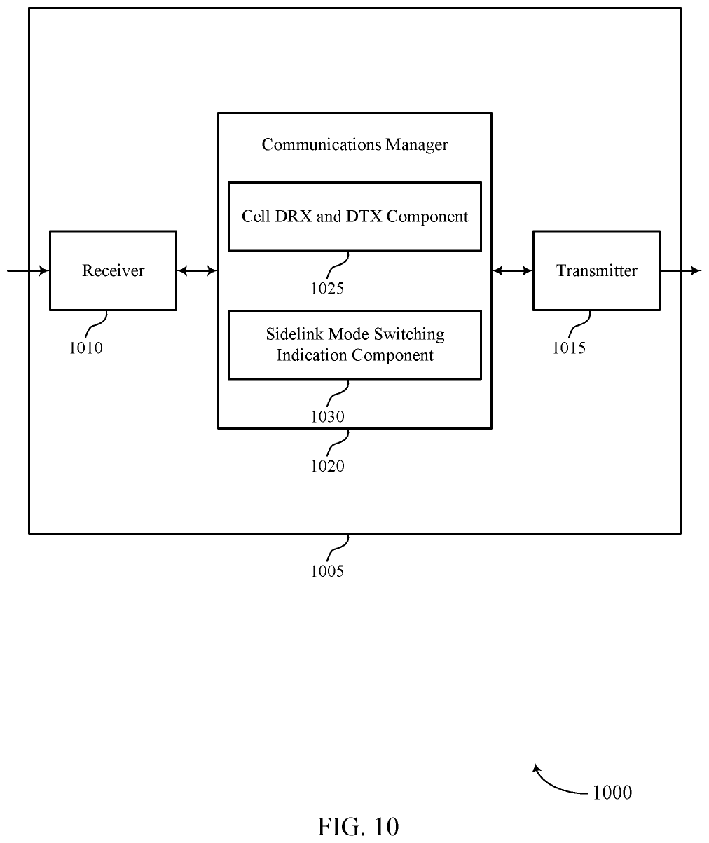

FIG. 10 shows a block diagram 1000 of a device 1005 that supports techniques for sidelink mode switching in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include one or more processors. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for sidelink mode switching as described herein. For example, the communications manager 1020 may include a cell DRX and DTX component 1025 a sidelink mode switching indication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The cell DRX and DTX component 1025 is capable of, configured to, or operable to support a means for transmitting control signaling indicating a configuration that identifies a pattern where the network entity cycles over time between a first network operation state and a second network operation state, the second network operation state associated with lower power consumption than the first network operation state. The sidelink mode switching indication component 1030 is capable of, configured to, or operable to support a means for communicating, with a UE, an indication to switch from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

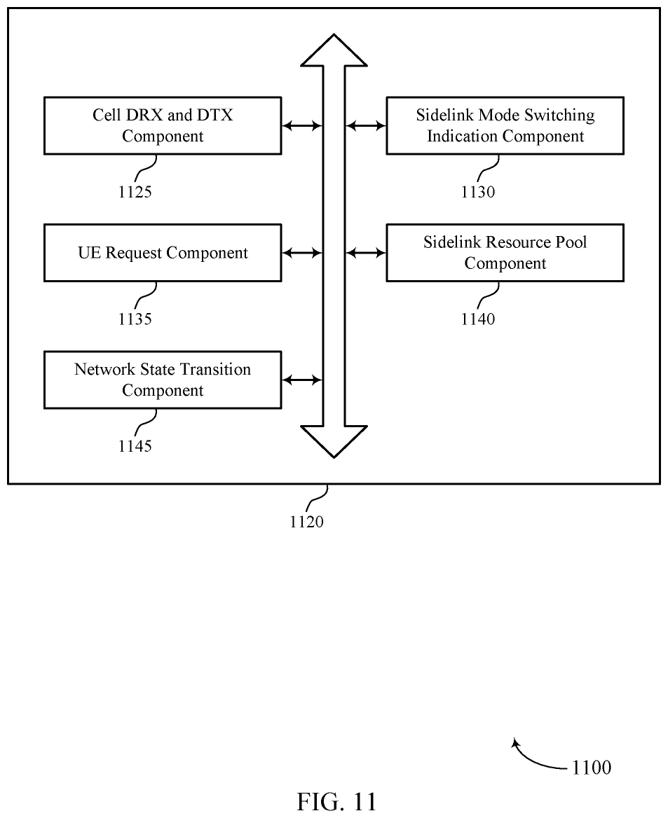

FIG. 11 shows a block diagram 1100 of a communications manager 1120 that supports techniques for sidelink mode switching in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for sidelink mode switching as described herein. For example, the communications manager 1120 may include a cell DRX and DTX component 1125, a sidelink mode switching indication component 1130, a UE request component 1135, a sidelink resource pool component 1140, a network state transition component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The cell DRX and DTX component 1125 is capable of, configured to, or operable to support a means for transmitting control signaling indicating a configuration that identifies a pattern where the network entity cycles over time between a first network operation state and a second network operation state, the second network operation state associated with lower power consumption than the first network operation state. The sidelink mode switching indication component 1130 is capable of, configured to, or operable to support a means for communicating, with a UE, an indication to switch from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

In some examples, to support communicating with the UE, the UE request component 1135 is capable of, configured to, or operable to support a means for receiving, from the UE, a request to switch from the first sidelink mode of operation to the second sidelink mode of operation in response to the control signaling.

In some examples, to support communicating with the UE, the sidelink mode switching indication component 1130 is capable of, configured to, or operable to support a means for transmitting, to the UE, an indication to switch from the first sidelink mode of operation to the second sidelink mode of operation in response to the control signaling.

In some examples, the sidelink resource pool component 1140 is capable of, configured to, or operable to support a means for transmitting, via the control signaling, an indication of a resource pool associated with the second sidelink mode of operation, the resource pool dedicated for sidelink communications at the UE when switching from the first sidelink mode of operation to the second sidelink mode of operation.

In some examples, the network state transition component 1145 is capable of, configured to, or operable to support a means for transmitting an indication of a transition by the network entity between the first network operation state and the second network operation state, where communicating the indication to switch is based on the indication of the transition between the first network operation state and the second network operation state.

In some examples, the network state transition component 1145 is capable of, configured to, or operable to support a means for transmitting, via the control signaling, a timer associated with a transition by the network entity between the first network operation state and the second network operation state, where communicating the indication to switch is based on expiration of the timer associated with the transition between the first network operation state and the second network operation state.

In some examples, the network state transition component 1145 is capable of, configured to, or operable to support a means for transmitting signaling indicative of a transition by the network entity between the first network operation state and the second network operation state, where communicating the indication to switch is based on receiving the signaling.

In some examples, the first network operation state is an active state of a DTX cycle of the network entity and the second network operation state is an inactive state of the DTX cycle of the network entity.

In some examples, the first network operation state is an active state of a DRX cycle of the network entity and the second network operation state is an inactive state of the DRX cycle of the network entity.

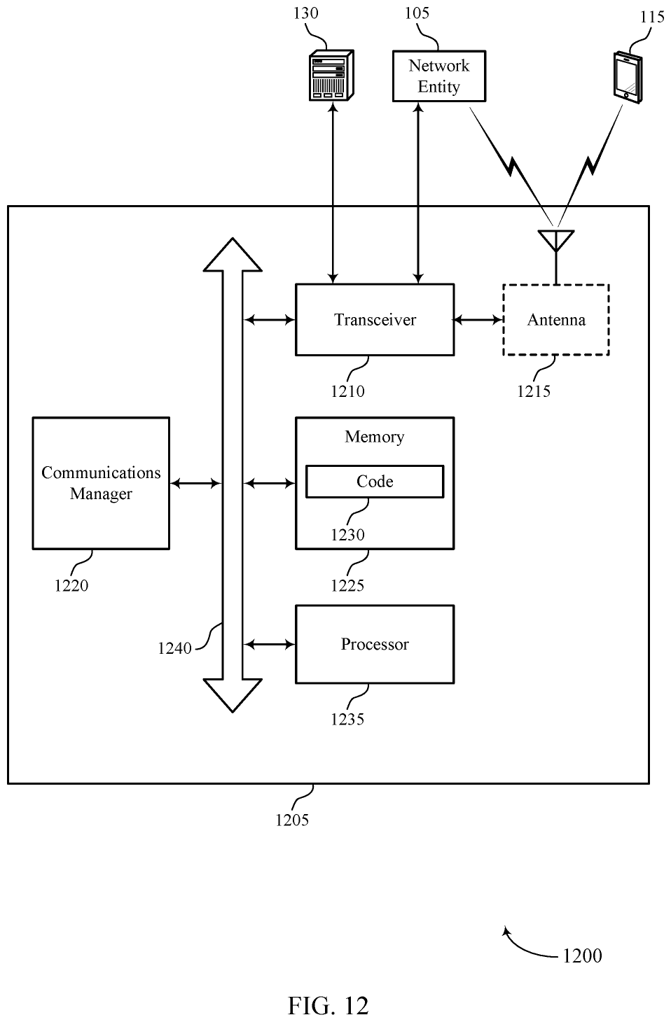

FIG. 12 shows a diagram of a system 1200 including a device 1205 that supports techniques for sidelink mode switching in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240). In some examples, the device 1205 may include one or more processors 1235 and one or more memories 1225 configured to perform the aspects as described herein.

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for sidelink mode switching). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225).

In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components.

For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for transmitting control signaling indicating a configuration that identifies a pattern where the network entity cycles over time between a first network operation state and a second network operation state, the second network operation state associated with lower power consumption than the first network operation state. The communications manager 1220 is capable of, configured to, or operable to support a means for communicating, with a UE, an indication to switching from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation.

By including or configuring the communications manager 1220 in accordance with examples as described herein, the device 1205 may support techniques for the UE to switch from a first sidelink mode of operation to a second sidelink mode of operation in response to cell DRX or cell DTX cycles of the network entity, which may result in improved communication reliability, reduced latency, a more efficient utilization of communication resources.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of techniques for sidelink mode switching as described herein, or the processor 1235 and the memory 1225 may be otherwise configured to perform or support such operations.

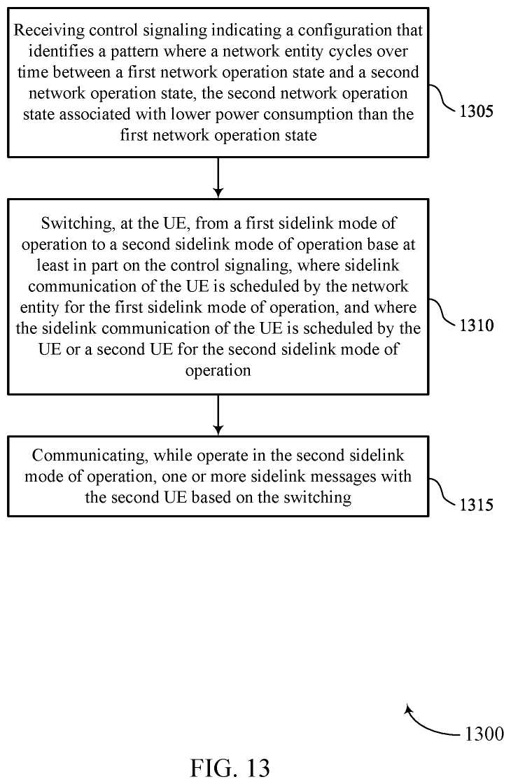

FIG. 13 shows a flowchart illustrating a method 1300 that supports techniques for sidelink mode switching in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving control signaling indicating a configuration that identifies a pattern where a network entity cycles over time between a first network operation state and a second network operation state, the second network operation state associated with lower power consumption than the first network operation state. The operations of 1305 may be performed in accordance with examples as disclosed herein. In some examples, aspects of the operations of 1305 may be performed by a control signaling component 725 as described with reference to FIG. 7.

At 1310, the method may include switching, at the UE, from a first sidelink mode of operation to a second sidelink mode of operation based on the control signaling, where sidelink communication of the UE is scheduled by the network entity for the first sidelink mode of operation, and where the sidelink communication of the UE is scheduled by the UE or a second UE for the second sidelink mode of operation. The operations of 1310 may be performed in accordance with examples as disclosed herein. In some examples, aspects of the operations of 1310 may be performed by a sidelink mode switching component 730 as described with reference to FIG. 7.

At 1315, the method may include communicating, while operating in the second sidelink mode of operation, one or more sidelink messages with the second UE based on the switching. The operations of 1315 may be performed in accordance with examples as disclosed herein. In some examples, aspects of the operations of 1315 may be performed by a sidelink communications component 735 as described with reference to FIG. 7.

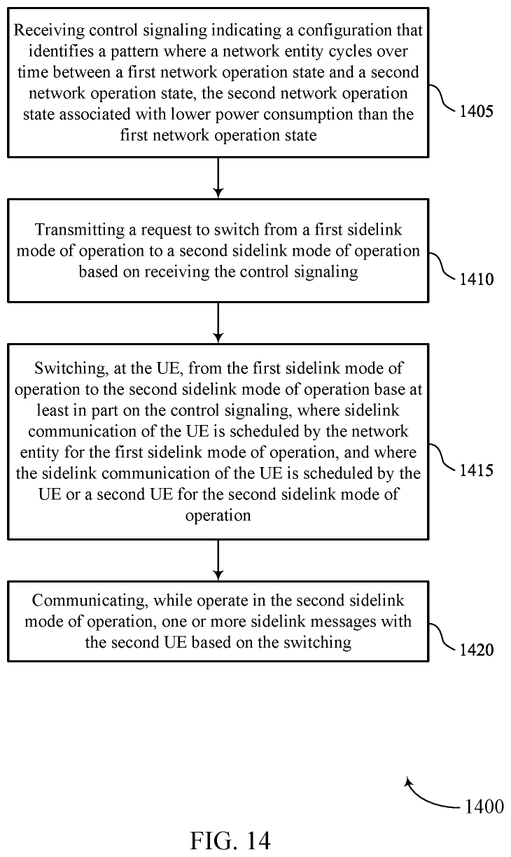

FIG. 14 shows a flowchart illustrating a method 1400 that supports techniques for sidelink mode switching in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving control signaling indicating a configuration that identifies a pattern where a network entity cycles over time between a first network operation state and a second network operation state, the second network operation state associated with lower power consumption than the first network operation state. The operations of 1405 may be performed in accordance with examples as disclosed herein. In some examples, aspects of the operations of 1405 may be performed by a control signaling component 725 as described with reference to FIG. 7.

At 1410, the method may include transmitting a request to switch from a first sidelink mode of operation to a second sidelink mode of operation based on receiving the control signaling. The operations of 1410 may be performed in accordance with examples as disclosed herein. In some examples, aspects of the operations of 1410 may be performed by a UE request component 740 as described with reference to FIG. 7.

At 1415, the method may include switching, at the UE, from the first sidelink mode of operation to the second sidelink mode of operation based on the control signaling and the request, where sidelink communication of the UE is scheduled by the network entity for the first sidelink mode of operation, and where the sidelink communication of the UE is scheduled by the UE or a second UE for the second sidelink mode of operation. The operations of 1415 may be performed in accordance with examples as disclosed herein. In some examples, aspects of the operations of 1415 may be performed by a sidelink mode switching component 730 as described with reference to FIG. 7.

At 1420, the method may include communicating, while operating in the second sidelink mode of operation, one or more sidelink messages with the second UE based on the switching. The operations of 1420 may be performed in accordance with examples as disclosed herein. In some examples, aspects of the operations of 1420 may be performed by a sidelink communications component 735 as described with reference to FIG. 7.

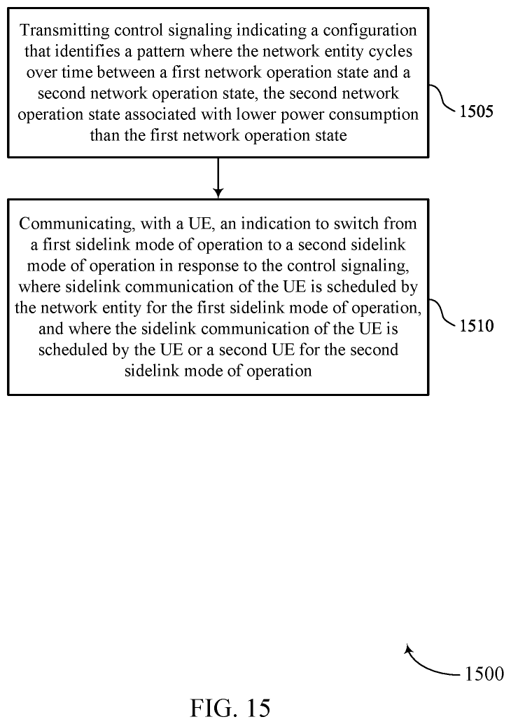

FIG. 15 shows a flowchart illustrating a method 1500 that supports techniques for sidelink mode switching in accordance with aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1505, the method may include transmitting control signaling indicating a configuration that identifies a pattern where the network entity cycles over time between a first network operation state and a second network operation state, the second network operation state associated with lower power consumption than the first network operation state. The operations of 1505 may be performed in accordance with examples as disclosed herein. In some examples, aspects of the operations of 1505 may be performed by a cell DRX and DTX component 1125 as described with reference to FIG. 11.

At 1510, the method may include communicating, with a UE, an indication to switch from a first sidelink mode of operation to a second sidelink mode of operation in response to the control signaling, where sidelink communication of the UE is scheduled by the network entity for the first sidelink mode of operation, and where the sidelink communication of the UE is scheduled by the UE or a second UE for the second sidelink mode of operation. The operations of 1510 may be performed in accordance with examples as disclosed herein. In some examples, aspects of the operations of 1510 may be performed by a sidelink mode switching indication component 1130 as described with reference to FIG. 11.

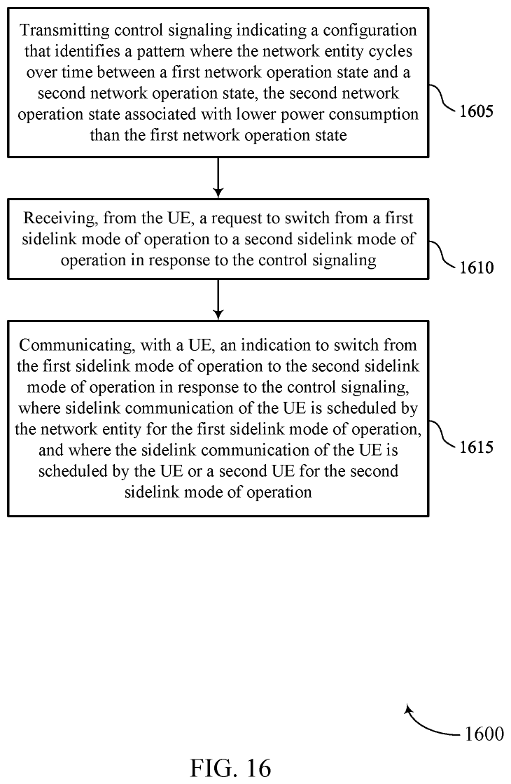

FIG. 16 shows a flowchart illustrating a method 1600 that supports techniques for sidelink mode switching in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include transmitting control signaling indicating a configuration that identifies a pattern where the network entity cycles over time between a first network operation state and a second network operation state, the second network operation state associated with lower power consumption than the first network operation state. The operations of 1605 may be performed in accordance with examples as disclosed herein. In some examples, aspects of the operations of 1605 may be performed by a cell DRX and DTX component 1125 as described with reference to FIG. 11.

At 1610, the method may include receiving, from the UE, a request to switch from a first sidelink mode of operation to a second sidelink mode of operation in response to the control signaling. The operations of 1610 may be performed in accordance with examples as disclosed herein. In some examples, aspects of the operations of 1610 may be performed by a UE request component 1135 as described with reference to FIG. 11.

At 1615, the method may include communicating, with a UE, an indication to switch from the first sidelink mode of operation to the second sidelink mode of operation in response to the control signaling and the request, where sidelink communication of the UE is scheduled by the network entity for the first sidelink mode of operation, and where the sidelink communication of the UE is scheduled by the UE or a second UE for the second sidelink mode of operation. The operations of 1615 may be performed in accordance with examples as disclosed herein. In some examples, aspects of the operations of 1615 may be performed by a sidelink mode switching indication component 1130 as described with reference to FIG. 11.

The following provides an overview of aspects of the present disclosure:

Aspect 1: A method for wireless communications at a UE, comprising: receiving control signaling indicating a configuration that identifies a pattern where a network entity cycles over time between a first network operation state and a second network operation state, the second network operation state associated with lower power consumption than the first network operation state; switching, at the UE, from a first sidelink mode of operation to a second sidelink mode of operation based at least in part on the control signaling, wherein sidelink communication of the UE is scheduled by the network entity for the first sidelink mode of operation, and wherein the sidelink communication of the UE is scheduled by the UE or a second UE for the second sidelink mode of operation; and communicating, while operating in the second sidelink mode of operation, one or more sidelink messages with the second UE based at least in part on the switching.

Aspect 2: The method of aspect 1, further comprising: transmitting a request to switch from the first sidelink mode of operation to the second sidelink mode of operation based at least in part on receiving the control signaling, wherein the switching is based at least in part on transmitting the request.

Aspect 3: The method of any of aspects 1 through 2, further comprising: receiving an indication to switch from the first sidelink mode of operation to the second sidelink mode of operation, wherein the switching is based at least in part on receiving the indication.

Aspect 4: The method of any of aspects 1 through 3, further comprising: receiving, via the control signaling, an indication of a resource pool associated with the second sidelink mode of operation, wherein communicating the one or more sidelink messages to the second UE is via resources scheduled from the resource pool.

Aspect 5: The method of aspect 4, wherein the switching from the first sidelink mode of operation to the second sidelink mode of operation is based at least in part on receiving the indication of the resource pool via the control signaling.

Aspect 6: The method of any of aspects 1 through 5, further comprising: receiving an indication of a transition by the network entity between the first network operation state and the second network operation state, wherein the switching is based at least in part on the indication of the transition between the first network operation state and the second network operation state.

Aspect 7: The method of any of aspects 1 through 6, further comprising: receiving, via the control signaling, an indication of a timer associated with a transition by the network entity between the first network operation state and the second network operation state, wherein the switching is based at least in part on expiration of the timer associated with the transition between the first network operation state and the second network operation state.

Aspect 8: The method of any of aspects 1 through 7, further comprising: receiving signaling indicative of a transition by the network entity between the first network operation state and the second network operation state, wherein the switching is based at least in part on receiving the signaling.

Aspect 9: The method of any of aspects 1 through 8, wherein switching from the first sidelink mode of operation to the second sidelink mode of operation is based at least in part on a duration of the second network operation state satisfying a timing threshold.

Aspect 10: The method of any of aspects 1 through 9, wherein switching from the first sidelink mode of operation to the second sidelink mode of operation is based at least in part on one of a duration of the first network operation state or a duty cycle of the first network operation state failing to satisfy a timing threshold.

Aspect 11: The method of any of aspects 1 through 10, wherein the switching further comprises: switching from the first sidelink mode of operation to the second sidelink mode of operation for a subset of the one or more sidelink messages based at least in part on one of a packet delay budget of each of the subset of the one or more sidelink messages, a periodicity of each of the subset of the one or more sidelink messages, or each of the subset of the one or more sidelink messages being generated during the second network operation state.

Aspect 12: The method of any of aspects 1 through 11, wherein the first network operation state is an active state of a DTX cycle of the network entity and the second network operation state is an inactive state of the DTX cycle of the network entity.

Aspect 13: The method of any of aspects 1 through 12, wherein the first network operation state is an active state of a DRX cycle of the network entity and the second network operation state is an inactive state of the DRX cycle of the network entity.

Aspect 14: A method for wireless communications at a network entity, comprising: transmitting control signaling indicating a configuration that identifies a pattern where the network entity cycles over time between a first network operation state and a second network operation state, the second network operation state associated with lower power consumption than the first network operation state; and communicating, with a UE, an indication to switch from a first sidelink mode of operation to a second sidelink mode of operation in response to the control signaling, wherein sidelink communication of the UE is scheduled by the network entity for the first sidelink mode of operation, and wherein the sidelink communication of the UE is scheduled by the UE or a second UE for the second sidelink mode of operation.

Aspect 15: The method of aspect 14, wherein communicating with the UE further comprises: receiving, from the UE, a request to switch from the first sidelink mode of operation to the second sidelink mode of operation in response to the control signaling.

Aspect 16: The method of any of aspects 14 through 15, wherein communicating with the UE further comprises: transmitting, to the UE, an indication to switch from the first sidelink mode of operation to the second sidelink mode of operation in response to the control signaling.

Aspect 17: The method of any of aspects 14 through 16, further comprising: transmitting, via the control signaling, an indication of a resource pool associated with the second sidelink mode of operation, the resource pool dedicated for sidelink communications at the UE when switching from the first sidelink mode of operation to the second sidelink mode of operation.

Aspect 18: The method of any of aspects 14 through 17, further comprising: transmitting an indication of a transition by the network entity between the first network operation state and the second network operation state, wherein communicating the indication to switch is based at least in part on the indication of the transition between the first network operation state and the second network operation state.

Aspect 19: The method of any of aspects 14 through 18, further comprising: transmitting, via the control signaling, a timer associated with a transition by the network entity between the first network operation state and the second network operation state, wherein communicating the indication to switch is based at least in part on expiration of the timer associated with the transition between the first network operation state and the second network operation state.

Aspect 20: The method of any of aspects 14 through 19, further comprising: transmitting signaling indicative of a transition by the network entity between the first network operation state and the second network operation state, wherein communicating the indication to switch is based at least in part on receiving the signaling.

Aspect 21: The method of any of aspects 14 through 20, wherein the first network operation state is an active state of a DTX cycle of the network entity and the second network operation state is an inactive state of the DTX cycle of the network entity.

Aspect 22: The method of any of aspects 14 through 21, wherein the first network operation state is an active state of a DRX cycle of the network entity and the second network operation state is an inactive state of the DRX cycle of the network entity.

Aspect 23: An apparatus for wireless communications at a UE, comprising one or more processors; one or more memories coupled with the one or more processors; and instructions stored in the one or more memories and executable by the one or more processors to cause the apparatus to perform a method of any of aspects 1 through 13.

Aspect 24: An apparatus for wireless communications at a UE, comprising at least one means for performing a method of any of aspects 1 through 13.

Aspect 25: A non-transitory computer-readable medium storing code for wireless communications at a UE, the code comprising instructions executable by one or more processors to perform a method of any of aspects 1 through 13.

Aspect 26: An apparatus for wireless communications at a network entity, comprising one or more processors; one or more memories coupled with the one or more processors; and instructions stored in the one or more memories and executable by the one or more processors to cause the apparatus to perform a method of any of aspects 14 through 22.

Aspect 27: An apparatus for wireless communications at a network entity, comprising at least one means for performing a method of any of aspects 14 through 22.

Aspect 28: A non-transitory computer-readable medium storing code for wireless communications at a network entity, the code comprising instructions executable by one or more processors to perform a method of any of aspects 14 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by one or more processors, firmware, or any combination thereof. If implemented using software executed by one or more processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors;
one or more memories coupled with the one or more processors; and
instructions stored in the one or more memories and executable by the one or more processors to cause the apparatus to:
receive control signaling indicating a configuration that identifies a pattern where a network entity cycles over time between a first network operation state and a second network operation state, the second network operation state associated with lower power consumption than the first network operation state;
switch, at the UE, from a first sidelink mode of operation to a second sidelink mode of operation base at least in part on the control signaling,
wherein sidelink communication of the UE is scheduled by the network entity for the first sidelink mode of operation, and wherein the sidelink communication of the UE is scheduled by the UE or a second UE for the second sidelink mode of operation; and
communicate, while operating in the second sidelink mode of operation, one or more sidelink messages with the second UE based at least in part on the switch.

2. The apparatus of claim 1, wherein the instructions are further executable by the one or more processors to cause the apparatus to:
transmit a request to switch from the first sidelink mode of operation to the second sidelink mode of operation based at least in part on the control signaling,
wherein the instructions are executable by the one or more processors to cause the apparatus to switch from the first sidelink mode of operation to the second sidelink mode of operation based at least in part on the request.

3. The apparatus of claim 1, wherein the instructions are further executable by the one or more processors to cause the apparatus to:
receive an indication to switch from the first sidelink mode of operation to the second sidelink mode of operation,
wherein the instructions are executable by the one or more processors to cause the apparatus to switch from the first sidelink mode of operation to the second sidelink mode of operation based at least in part on the indication.

4. The apparatus of claim 1, wherein the instructions are further executable by the one or more processors to cause the apparatus to:
receive, via the control signaling, an indication of a resource pool associated with the second sidelink mode of operation,
wherein the instructions are executable by the one or more processors to cause the apparatus to communicate the one or more sidelink messages to the second UE via resources scheduled from the resource pool.

5. The apparatus of claim 4, wherein the instructions are executable by the one or more processors to cause the apparatus to switch from the first sidelink mode of operation to the second sidelink mode of operation based at least in part on the indication of the resource pool.

6. The apparatus of claim 1, wherein the instructions are further executable by the one or more processors to cause the apparatus to:
receive an indication of a transition by the network entity between the first network operation state and the second network operation state,
wherein the instructions are executable by the one or more processors to cause the apparatus to switch from the first sidelink mode of operation to the second sidelink mode of operation based at least in part on the indication of the transition between the first network operation state and the second network operation state.

7. The apparatus of claim 1, wherein the instructions are further executable by the one or more processors to cause the apparatus to:
receive, via the control signaling, an indication of a timer associated with a transition by the network entity between the first network operation state and the second network operation state,
wherein the instructions are executable by the one or more processors to cause the apparatus to switch from the first sidelink mode of operation to the second sidelink mode of operation based at least in part on expiration of the timer associated with the transition between the first network operation state and the second network operation state.

8. The apparatus of claim 1, wherein the instructions are further executable by the one or more processors to cause the apparatus to:
receive signaling indicative of a transition by the network entity between the first network operation state and the second network operation state,
wherein the instructions are executable by the one or more processors to cause the apparatus to switch from the first sidelink mode of operation to the second sidelink mode of operation based at least in part on the signaling.

9. The apparatus of claim 1, wherein the instructions are executable by the one or more processors to cause the apparatus to switch from the first sidelink mode of operation to the second sidelink mode of operation based at least in part on a duration of the second network operation state satisfying a timing threshold.

10. The apparatus of claim 1, wherein the instructions are executable by the one or more processors to cause the apparatus to switch from the first sidelink mode of operation to the second sidelink mode of operation based at least in part on one of a duration of the first network operation state or a duty cycle of the first network operation state failing to satisfy a timing threshold.

11. The apparatus of claim 1, wherein the instructions to switch are further executable by the one or more processors to cause the apparatus to:
switch from the first sidelink mode of operation to the second sidelink mode of operation for a subset of the one or more sidelink messages based at least in part on one of a packet delay budget of each of the subset of the one or more sidelink messages, a periodicity of each of the subset of the one or more sidelink messages, or each of the subset of the one or more sidelink messages being generated during the second network operation state.

12. The apparatus of claim 1, wherein the first network operation state is an active state of a discontinuous transmission cycle of the network entity and the second network operation state is an inactive state of the discontinuous transmission cycle of the network entity.

13. The apparatus of claim 1, wherein the first network operation state is an active state of a discontinuous reception cycle of the network entity and the second network operation state is an inactive state of the discontinuous reception cycle of the network entity.

14. An apparatus for wireless communications at a network entity, comprising:
one or more processors;
one or more memories coupled with the one or more processors; and
instructions stored in the one or more memories and executable by the one or more processors to cause the apparatus to:
transmit control signaling indicating a configuration that identifies a pattern where the network entity cycles over time between a first network operation state and a second network operation state, the second network operation state associated with lower power consumption than the first network operation state; and
communicate, with a user equipment (UE), a message indicating for the UE to switch from a first sidelink mode of operation to a second sidelink mode of operation in response to the control signaling,
wherein sidelink communication of the UE is scheduled by the network entity for the first sidelink mode of operation, and wherein the sidelink communication of the UE is scheduled by the UE or a second UE for the second sidelink mode of operation.

15. The apparatus of claim 14, wherein the instructions to communicate with the UE are further executable by the one or more processors to cause the apparatus to:
receive, from the UE, a request to switch from the first sidelink mode of operation to the second sidelink mode of operation in response to the control signaling.

16. The apparatus of claim 14, wherein the instructions to communicate with the UE are further executable by the one or more processors to cause the apparatus to:
transmit, to the UE, an indication to switch from the first sidelink mode of operation to the second sidelink mode of operation in response to the control signaling.

17. The apparatus of claim 14, wherein the instructions are further executable by the one or more processors to cause the apparatus to:
transmit, via the control signaling, an indication of a resource pool associated with the second sidelink mode of operation, the resource pool dedicated for sidelink communications at the UE when switching from the first sidelink mode of operation to the second sidelink mode of operation.

18. The apparatus of claim 14, wherein the instructions are further executable by the one or more processors to cause the apparatus to:
transmit an indication of a transition by the network entity between the first network operation state and the second network operation state,
wherein the instructions are executable by the one or more processors to cause the apparatus to communicate the indication to switch based at least in part on the indication of the transition between the first network operation state and the second network operation state.

19. The apparatus of claim 14, wherein the instructions are further executable by the one or more processors to cause the apparatus to:
transmit, via the control signaling, a timer associated with a transition by the network entity between the first network operation state and the second network operation state,
wherein the instructions are executable by the one or more processors to cause the apparatus to communicate the message to switch based at least in part on expiration of the timer associated with the transition between the first network operation state and the second network operation state.

20. The apparatus of claim 14, wherein the instructions are further executable by the one or more processors to cause the apparatus to:
transmit signaling indicative of a transition by the network entity between the first network operation state and the second network operation state,
wherein the instructions are executable by the one or more processors to cause the apparatus to communicate the message based at least in part on the signaling.

21. The apparatus of claim 14, wherein the first network operation state is an active state of a discontinuous transmission cycle of the network entity and the second network operation state is an inactive state of the discontinuous transmission cycle of the network entity.

22. The apparatus of claim 14, wherein the first network operation state is an active state of a discontinuous reception cycle of the network entity and the second network operation state is an inactive state of the discontinuous reception cycle of the network entity.

23. A method for wireless communications at a user equipment (UE), comprising:
receiving control signaling indicating a configuration that identifies a pattern where a network entity cycles over time between a first network operation state and a second network operation state, the second network operation state associated with lower power consumption than the first network operation state;
switching, at the UE, from a first sidelink mode of operation to a second sidelink mode of operation based at least in part on the control signaling,
wherein sidelink communication of the UE is scheduled by the network entity for the first sidelink mode of operation, and wherein the sidelink communication of the UE is scheduled by the UE or a second UE for the second sidelink mode of operation; and
communicating, while operating in the second sidelink mode of operation, one or more sidelink messages with the second UE based at least in part on the switching.

24. The method of claim 23, further comprising:
transmitting a request to switch from the first sidelink mode of operation to the second sidelink mode of operation based at least in part on receiving the control signaling,
wherein the switching is based at least in part on transmitting the request.

25. The method of claim 23, further comprising:
receiving an indication to switch from the first sidelink mode of operation to the second sidelink mode of operation,
wherein the switching is based at least in part on receiving the indication.

26. The method of claim 23, further comprising:
receiving, via the control signaling, an indication of a resource pool associated with the second sidelink mode of operation,
wherein communicating the one or more sidelink messages to the second UE is via resources scheduled from the resource pool.

27. A method for wireless communications at a network entity, comprising:
transmitting control signaling indicating a configuration that identifies a pattern where the network entity cycles over time between a first network operation state and a second network operation state, the second network operation state associated with lower power consumption than the first network operation state; and
communicating, with a user equipment (UE), a message indicating for the UE to switch from a first sidelink mode of operation to a second sidelink mode of operation in response to the control signaling,
wherein sidelink communication of the UE is scheduled by the network entity for the first sidelink mode of operation, and wherein the sidelink communication of the UE is scheduled by the UE or a second UE for the second sidelink mode of operation.

28. The method of claim 27, wherein communicating with the UE further comprises:
receiving, from the UE, a request to switch from the first sidelink mode of operation to the second sidelink mode of operation in response to the control signaling.

29. The method of claim 27, wherein communicating with the UE further comprises:
transmitting, to the UE, an indication to switch from the first sidelink mode of operation to the second sidelink mode of operation in response to the control signaling.

30. The method of claim 27, further comprising:
transmitting, via the control signaling, an indication of a resource pool associated with the second sidelink mode of operation, the resource pool dedicated for sidelink communications at the UE when switching from the first sidelink mode of operation to the second sidelink mode of operation.
